(19) United States
(12) Patent Application Publication
(10) Pub. No.: US 2026/0285034 A1
(43) Pub. Date: Sep. 24, 2026

(54) LIQUID DISCHARGE APPARATUS AND HEAD UNIT

(71) Applicant: SEIKO EPSON CORPORATION, Tokyo (JP)

(72) Inventors: Tomonori YAMADA, Shiojiri (JP); Toru MATSUYAMA, Matsumoto (JP)

(21) Appl. No.: 19/571,646

(22) Filed: Mar. 19, 2026

(30) Foreign Application Priority Data
Mar. 21, 2025 (JP) 2025-047304

(51) Int. Cl. B41J 2/045; B41J 2/14

(52) U.S. Cl. CPC B41J 2/0451; B41J 2/04541; B41J 2/0455; B41J 2/04573; B41J 2/04581; B41J 2/14233

(57) ABSTRACT

A liquid discharge apparatus includes a discharge section configured to discharge liquid, a detection circuit configured to detect residual vibration generated in the discharge section, a determination circuit configured to determine the discharge section is normal, a first transmission gate to which a first voltage signal is supplied and configured to switch selectively couple the discharge section and the detection circuit, a first signal output circuit to which a second voltage is input and configured to output a first signal held at the first voltage, and a second signal output circuit to which the second voltage is input and configured to output a second signal held at the first voltage, in which the first voltage signal is a signal obtained by synthesizing at least the first signal and the second signal.

The present application is based on, and claims priority from JP Application Serial Number 2025-047304, filed Mar. 21, 2025, the disclosure of which is hereby incorporated by reference herein in its entirety.

### BACKGROUND

### 1. Technical Field

The present disclosure relates to a liquid discharge apparatus and a head unit.

### 2. Related Art

A liquid discharge apparatus such as an ink jet printer which forms an image on a medium such as a recording paper by discharging liquid such as ink from a discharge section is widely known. In the liquid discharge apparatus, a discharge abnormality in which the liquid cannot be normally discharged from the discharge section may occur, and the image quality of the image formed on the medium may deteriorate due to the discharge abnormality. In order to grasp such discharge abnormality, in the related art, a technique related to discharge state determination for determining a discharge state of liquid in the discharge section has been proposed. For example, JP-A-2015-174239 describes a technique related to discharge state determination for determining the discharge state of liquid in the discharge section based on characteristics such as amplitudes and periods of residual vibration generated in the discharge section driven by a drive signal for inspection.

In a circuit configuration as described in JP-A-2015-174239, it is assumed that a transmission gate is used to extract a very weak signal based on residual vibration. However, there has been a problem in that ripple contained in a constant voltage signal supplied to the transmission gate becomes noise and is superimposed on the very weak signal, thereby causing erroneous detection.

In order to solve such a problem, the inventor of the present application has found a new method for stabilizing operation of the transmission gate so as not to affect the residual vibration to be detected.

### SUMMARY

A liquid discharge apparatus according to the present disclosure includes a transport section configured to transport a medium, a discharge section configured to discharge liquid by supply of a drive signal, a detection circuit configured to detect residual vibration generated in the discharge section, a determination circuit configured to determine whether or not the discharge section is normal in accordance with the residual vibration detected by the detection circuit, a first transmission gate to which a first voltage signal held at a first voltage is supplied, the first transmission gate being configured to selectively couple the discharge section and the detection circuit, a first signal output circuit to which a second voltage different from the first voltage is input, the first signal output circuit being configured to output a first signal held at the first voltage by switching on and off of a first switching element, and a second signal output circuit to which the second voltage is input, the second signal output circuit being configured to output a second signal held at the first voltage by switching on and off of a second switching element at a timing different from a timing at which the first switching element is switched on and off, in which the first voltage signal is a signal obtained by synthesizing at least the first signal and the second signal.

A head unit according to the present disclosure includes a discharge section configured to discharge liquid by supply of a drive signal, a detection circuit configured to detect residual vibration generated in the discharge section, a determination circuit configured to determine whether or not the discharge section is normal in accordance with the residual vibration detected by the detection circuit, a first transmission gate to which a first voltage signal held at a first voltage is supplied, the first transmission gate being configured to selectively couple the discharge section and the detection circuit, a first signal output circuit to which a second voltage different from the first voltage is input, the first signal output circuit being configured to output a first signal held at the first voltage by switching on and off of a first switching element, and a second signal output circuit to which the second voltage is input, the second signal output circuit being configured to output a second signal held at the first voltage by switching on and off of a second switching element at a timing different from a timing at which the first switching element is switched on and off, in which the first voltage signal is a signal obtained by synthesizing at least the first signal and the second signal.

### BRIEF DESCRIPTION OF THE DRAWINGS

FIG. 1 is a diagram illustrating a schematic configuration of a liquid discharge apparatus.

FIG. 2 is a diagram illustrating an example of a functional configuration of a head unit.

FIG. 3 is a diagram illustrating a schematic structure of a discharge section.

FIG. 4 is a diagram illustrating an example of a functional configuration of the print head.

FIG. 5 is a diagram illustrating an example of a configuration of a switch.

FIG. 6 is a diagram for explaining an example of various signals input to a coupling state designation circuit.

FIG. 7 is a diagram illustrating an example of a configuration of a waveform shaping circuit.

FIG. 8 is a diagram for explaining an example of various signals output by a control circuit in a period during which a discharge process is executed.

FIG. 9 is a diagram illustrating an example of a relationship between an individual designation signal Sd[m] and coupling state designation signals Qc[m] and Qs[m] in the period during which the discharge process is executed.

FIG. 10 is a diagram for explaining an example of various signals input to a supply switching circuit of a print head in the period during which determination process is executed.

FIG. 11 is a diagram illustrating an example of a relationship between the individual designation signal Sd[m] and the coupling state designation signals Qc[m] and Qs[m] in the period during which the determination process is executed.

FIG. 12 is a diagram illustrating an example of a relationship between the individual designation signal Sd[m] and coupling state designation signals Qf, Q1, and Q2 in the period during which the determination process is executed.

FIG. 13 is a diagram for explaining an example of operation of acquiring a detection potential signal based on a signal corresponding to residual vibration generated in a discharge section to be inspected.

FIG. 14 is a diagram illustrating an example of a functional configuration of a power supply circuit which is a step-down circuit.

FIG. 15 is a diagram illustrating an example of waveforms of control signals.

FIG. 16 is a diagram illustrating an example of a waveform of a power supply voltage signal VHV or a power supply voltage signal VDD output from a power supply circuit of a comparative example and the power supply circuit in the present embodiment.

FIG. 17 is a diagram illustrating an example of a functional configuration of a power supply circuit which is a step-up circuit.

FIG. 18 is a diagram illustrating an example of the waveform of the power supply voltage signal VHV or the power supply voltage signal VDD output from the power supply circuit of the comparative example and the power supply circuit in the present embodiment.

FIG. 19 is a diagram illustrating an example of a functional configuration of a head unit according to a modification.

FIG. 20 is a diagram illustrating an example of a functional configuration of a head unit according to another modification.

### DESCRIPTION OF EMBODIMENTS

Hereinafter, preferred embodiments of the present disclosure will be described in detail with reference to the drawings. The drawings to be used are for convenience of description. The embodiments to be described below do not unduly limit the contents of the present disclosure described in the scope of claims. Furthermore, not all of the configurations described below are essential constituent elements of the present disclosure.

### 1. CONFIGURATION OF LIQUID DISCHARGE APPARATUS

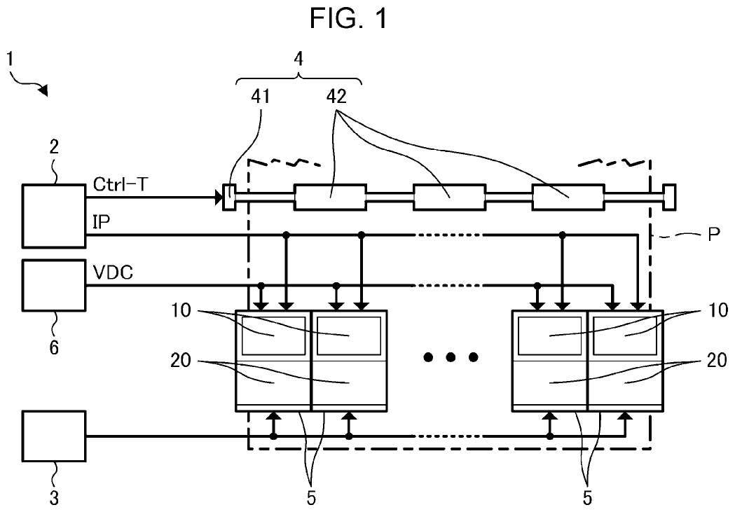

FIG. 1 is a diagram illustrating a schematic configuration of a liquid discharge apparatus 1. The liquid discharge apparatus 1 of the present embodiment is a so-called line-type ink jet printer that forms a desired image on a medium P by discharging ink as an example of liquid from each of a plurality of head units 5 at a desired timing with respect to the medium P transported by a transport unit 4. Note that the liquid discharge apparatus 1 is not limited to the line-type ink jet printer, and may be a serial-type ink jet printer. Further, the liquid discharge apparatus 1 is not limited to the ink jet printer, and may be a coloring material discharge apparatus used for manufacturing a color filter for a liquid crystal display or the like, an electrode material discharge apparatus used for forming an electrode for an organic EL display, a field emission display (FED), or the like, a bioorganic substance discharge apparatus used for manufacturing a biochip, and the like, and may be a three-dimensional shaping apparatus, a textile printing apparatus, or the like. Here, in the following description, a direction in which the medium P is transported may be referred to as a transport direction, and a width direction of the transported medium P may be referred to as a scanning direction.

As illustrated in FIG. 1, the liquid discharge apparatus 1 includes a control unit 2, a liquid container 3, a transport unit 4, a plurality of head units 5, and a power supply unit 6.

The power supply unit 6 generates, for example, a power supply voltage signal VDC, which is a DC voltage signal having a constant voltage value of 48 V or 36 V, from an AC voltage signal such as a commercial power supply or the like supplied to the liquid discharge apparatus 1, and outputs the power supply voltage signal VDC to each unit of the liquid discharge apparatus 1. Such a power supply unit 6 includes an AC/DC converter such as a flyback circuit. Further, in addition to the power supply voltage signal VDC, the power supply unit 6 may generate and output one or a plurality of DC voltage signals having voltage values different from that used as power supply voltages in the control unit 2, the liquid container 3, the transport unit 4, and the like. In this case, the power supply unit 6 may include a DC/DC converter in addition to the AC/DC converter described above.

The control unit 2 includes a processing circuit such as a central processing unit (CPU) and a field programmable gate array (FPGA), and a storage circuit such as a semiconductor memory. The control unit 2 generates and outputs various signals including a transport control signal Ctrl-T and an image information signal IP which are signals for controlling each element of the liquid discharge apparatus 1 based on image data supplied from an external device such as a host computer (not illustrated) provided outside the liquid discharge apparatus 1.

The liquid container 3 stores ink as an example of liquid to be supplied to the head unit 5. Specifically, the liquid container 3 stores a plurality of colors of ink to be discharged to the medium P such as black, cyan, magenta, yellow, red, and gray. As such a liquid container 3, an ink cartridge, a bag-shaped ink pack made of a flexible film, an ink tank capable of being refilled with ink, and the like can be used.

The transport unit 4 includes a transport motor 41 and a transport roller 42. The transport control signal Ctrl-T output by the control unit 2 is input to the transport unit 4. The transport motor 41 is driven based on the transport control signal Ctrl-T, and the transport roller 42 rotates as the transport motor 41 is driven. In accordance with rotation of the transport roller 42, the medium P is transported along the transport direction. That is, the liquid discharge apparatus 1 includes the transport unit 4 that transports the medium P.

Each of the plurality of head units 5 includes a drive module 10 and a discharge module 20. The power supply voltage signal VDC output by the power supply unit 6 and a corresponding image information signal IP output by the control unit 2 are input to each of the plurality of head units 5, and ink stored in the liquid container 3 is supplied to each of the plurality of head units 5 via an ink tube (not illustrated). The drive module 10 operates by using the power supply voltage signal VDC as drive power, and controls operation of the discharge module 20 based on the image information signal IP. As a result, the discharge module 20 discharges the ink supplied from the liquid container 3 at a predetermined timing in response to the control of the drive module 10.

In the liquid discharge apparatus 1 of the present embodiment, the discharge modules 20 included in each of the plurality of head units 5 are positioned side by side so as to have a length equal to or greater than the width of the medium P along the scanning direction. According to this, a line head is configured. Then, each of the plurality of head units 5 discharges ink onto the medium P at a timing synchronized with the transport of the medium P. As a result, the ink lands on a desired position of the medium P, and a desired image is formed on the medium P.

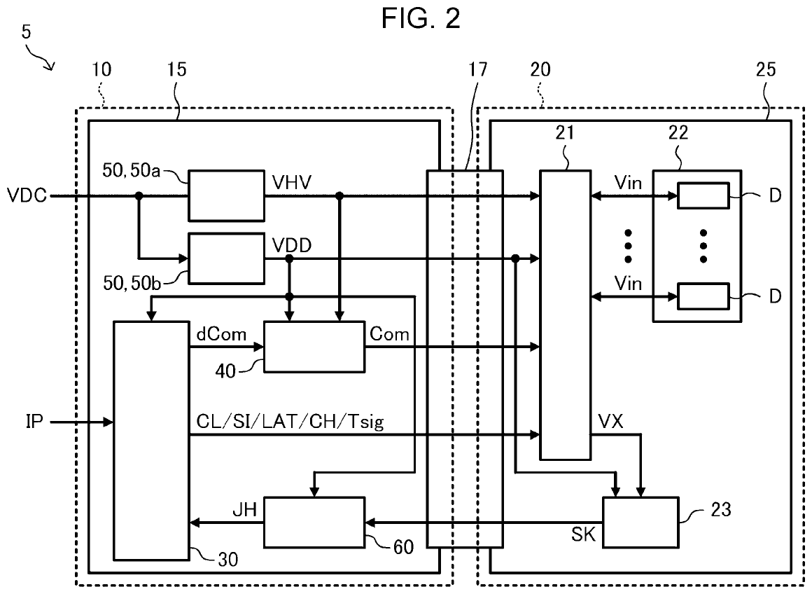

Here, a specific example of the configuration of the head unit 5 will be described. FIG. 2 is a diagram illustrating an example of a functional configuration of the head unit 5.

As described above, the power supply voltage signal VDC and the image information signal IP are input to the head unit 5. The head unit 5 forms an image corresponding to the image information signal IP on the medium P by being driven using the power supply voltage signal VDC as drive power.

As illustrated in FIG. 2, the head unit 5 includes the drive module 10 and the discharge module 20. The drive module 10 includes a wiring substrate 15, and a control circuit 30, a drive circuit 40, a power supply circuit 50(50a and 50b) and a determination circuit 60 which are provided on the wiring substrate 15. The discharge module 20 includes a print head 25. Then, the wiring substrate 15 and the print head 25 are electrically coupled to each other via a coupling member 17 which is a BtoB connector. Accordingly, the wiring substrate 15 and the print head 25 are communicably connected to each other. In other words, the print head 25 and the wiring substrate 15 are electrically coupled to each other via the coupling member 17 which is a BtoB connector. Here, the coupling member 17 is not limited to the BtoB connector, and may be a flexible flat cable or a flexible wiring substrate, and various connectors including the BtoB connector and the flexible flat cable or the flexible wiring substrate may be used in combination.

In the present embodiment, a case where the discharge module 20 includes one print head 25 will be described as an example, but the discharge module 20 may include a plurality of the print heads 25.

The power supply voltage signal VDC is input to the power supply circuits 50a and 50b. The power supply circuit 50a generates and outputs, for example, a power supply voltage signal VHV that is a DC voltage signal having a constant voltage value of 42 V by stepping down or stepping up the power supply voltage signal VDC. The power supply voltage signal VHV is supplied to the drive circuit 40 and is also supplied to the print head 25 via the coupling member 17. The power supply circuit 50b generates and outputs, for example, a power supply voltage signal VDD that is a DC voltage signal having a constant voltage value of 3.3 V by stepping down or stepping up the power supply voltage signal VDC. The power supply voltage signal VDD is supplied to the control circuit 30, the drive circuit 40, and the determination circuit 60, and is also supplied to the print head 25 via the coupling member 17. Note that the power supply circuit 50b may generate the power supply voltage signal VDD by stepping down the power supply voltage signal VHV.

Such power supply circuits 50a and 50b are configured as DC/DC converters including switching power supply circuits. However, the power supply circuits 50a and 50b may have a configuration in which an AC voltage signal such as a commercial power supply is input instead of the power supply voltage signal VDC. That is, the power supply circuits 50a and 50b may be AC/DC converters. The configuration of the power supply circuits 50a and 50b will be described in detail later.

The control circuit 30 controls operation of each configuration of the liquid discharge apparatus 1 including the drive circuit 40, the determination circuit 60, and the print head 25. The control circuit 30 includes one or a plurality of central processing units (CPU). The control circuit 30 may include a programmable logic device such as a field programmable gate array (FPGA) instead of the CPU or in addition to the CPU, and may further include a storage circuit. The control circuit 30 generates and outputs signals for controlling the operation of each portion of the head unit 5, such as a clock signal CL, a print data signal SI, a latch signal LAT, a change signal CH, a period designation signal Tsig, and a drive waveform designation signal dCom, according to the input image information signal IP. The control circuit 30 may further output a signal for controlling the output of the power supply voltage signals VHV and VDD from the power supply circuits 50a and 50b.

The drive waveform designation signal dCom is input to the drive circuit 40. The power supply voltage signal VHV is also input to the drive circuit 40. The drive circuit 40 generates and outputs a drive signal Com for driving a plurality of discharge sections D, which will be described later, included in the print head 25.

Specifically, the drive waveform designation signal dCom is a digital signal that defines a signal waveform of the drive signal Com, and the drive circuit 40 converts the input drive waveform designation signal dCom into an analog signal by a DA conversion circuit (not illustrated) and performs class-D amplification on the converted analog signal in accordance with the power supply voltage signal VHV to generate and output the drive signal Com obtained by amplifying the signal waveform defined by the drive waveform designation signal dCom. The drive circuit 40 may generate and output the drive signal Com by performing class-B amplification or class-AB amplification on the signal waveform defined by the drive waveform designation signal dCom in accordance with the power supply voltage signal VHV.

The clock signal CL, the print data signal SI, the latch signal LAT, the change signal CH, the period designation signal Tsig, and the drive signal Com are supplied to the print head 25 via the coupling member 17. The print data signal SI is a signal that propagates in synchronization with the clock signal CL, and is a digital signal that designates a type of the operation of the plurality of discharge sections D in each of the periods defined by the latch signal LAT, the change signal CH, and the period designation signal Tsig. Specifically, the print data signal SI is a signal including information for designating whether or not to supply the drive signal Com to each of the plurality of discharge sections D in each of periods defined by the latch signal LAT, the change signal CH, and the period designation signal Tsig, and accordingly, the operation of the corresponding discharge section D is individually designated.

The print head 25 includes a supply switching circuit 21, a recording head 22, and a detection circuit 23. Further, the recording head 22 includes the plurality of discharge sections D. Here, in the following description, it is assumed that the recording head 22 includes M discharge sections D. Then, when individually designating and describing the M discharge sections D, they are referred to as discharge sections D[1] to D[M]. At this time, when designating and describing the m-th discharge section D among the M discharge sections D, it may be referred to as the discharge section D[m]. Here, M is a natural number satisfying “M≥1”, and m is any natural number satisfying “1≤m≤M”. Further, in the following description, when indicating that a component, a signal, or the like of the liquid discharge apparatus 1 corresponds to the discharge section D[m] among the M discharge sections D, a subscript [m] may be added to a reference numeral indicating the component, the signal, or the like. That is, the print head 25 includes the plurality of discharge sections D and the supply switching circuit 21.

The clock signal CL, the print data signal SI, the latch signal LAT, the change signal CH, the period designation signal Tsig, the drive signal Com, and the power supply voltage signals VHV and VDD are input to the supply switching circuit 21. The supply switching circuit 21 switches whether or not to supply the drive signal Com as a supply drive signal Vin to a corresponding discharge section D based on the print data signal SI at each timing defined by the latch signal LAT, the change signal CH, and the period designation signal Tsig. When the supply drive signal Vin is supplied to a piezoelectric element PZ, which will be described later, included in the discharge section D, the piezoelectric element PZ is driven, and an amount of ink corresponding to the driving amount of the piezoelectric element PZ is discharged from the discharge section D. That is, the discharge section D discharges ink by the supply of the drive signal Com.

In addition, the supply switching circuit 21 switches whether or not to acquire a signal corresponding to a residual vibration generated in a discharge section D to be inspected based on the print data signal SI and supply the signal to the detection circuit 23 as a detection potential signal VX at each timing defined by the latch signal LAT, the change signal CH, and the period designation signal Tsig.

The detection circuit 23 detects residual vibration generated in the discharge section D to be inspected. Specifically, the detection circuit 23 generates and outputs a detection signal SK based on the detection potential signal VX. For example, the detection circuit 23 amplifies the input detection potential signal VX, removes a noise component, and then converts the signal into a digital signal to generate the detection signal SK. The detection signal SK is output from the print head 25 and input to the determination circuit 60 of the wiring substrate 15 via the coupling member 17.

The determination circuit 60 determines whether or not the discharge section D, which is the detection target, is normal according to the residual vibration detected by the detection circuit 23. Specifically, the determination circuit 60 determines whether or not the discharge state of ink in the discharge section D to be inspected is normal based on the detection signal SK. For example, the determination circuit 60 reads predetermined determination threshold information and correction value information from a storage circuit (not illustrated) including a non-volatile memory such as a read only memory (ROM) or a flash memory, corrects the detection signal SK according to the read correction value information, and compares the corrected signal with the predetermined determination threshold information. Then, the determination circuit 60 determines whether or not the discharge state of the discharge section D to be inspected is normal according to the comparison result, in other words, whether or not the discharge abnormality occurs in the discharge section D to be inspected. Then, the determination circuit 60 generates a state determination signal JH indicating the determination result and outputs the state determination signal JH to the control circuit 30. Here, in the following description, determining whether or not the discharge state of the discharge section D to be inspected is normal, or determining whether or not discharge abnormality occurs in the discharge section D to be inspected may be simply referred to as determining a state of the discharge section D to be inspected.

Here, the discharge abnormality is a general term for a state in which an abnormality occurs in a discharge state of ink from the discharge section D to be inspected, and a state in which the ink cannot be accurately discharged from the discharge section D to be inspected. Such a discharge abnormality includes, for example, a state in which ink cannot be discharged from the discharge section D, a state in which an ink amount different from an ink discharge amount defined by the drive signal Com is discharged from the discharge section D, a state in which the ink is discharged from the discharge section D at a speed different from an ink discharge speed defined by the drive signal Com, and the like.

As described above, when the discharge process of forming an image on the medium P by discharging ink is executed, the control circuit 30 generates a signal such as the print data signal SI for controlling the print head 25 such that ink is discharged based on the image information signal IP, and outputs the signal to the print head 25. In addition, the control circuit 30 generates a drive waveform designation signal dCom for controlling the drive circuit 40 so as to output a drive signal Com for driving the discharge section D so that ink is discharged, and outputs the drive waveform designation signal dCom to the drive circuit 40. The drive circuit 40 generates a drive signal Com in accordance with the drive waveform designation signal dCom and outputs the drive signal Com to the print head 25. As a result, presence or absence of ink discharge from each of the plurality of discharge sections D, the ink discharge amount, the ink discharge timing, and the like are controlled. As a result, an image corresponding to the image information signal IP is formed on the medium P.

In addition, when the determination process of determining the state of the discharge section D is executed, the control circuit 30 generates a signal such as the print data signal SI for determining the state of the discharge section D to be inspected, and outputs the signal to the print head 25. In addition, the control circuit 30 generates a drive waveform designation signal dCom for controlling the drive circuit 40 so as to output the drive signal Com for determining the state of the discharge section D, and outputs the drive waveform designation signal dCom to the drive circuit 40. The drive circuit 40 generates a drive signal Com in accordance with the drive waveform designation signal dCom and outputs the drive signal Com to the print head 25. Accordingly, the supply switching circuit 21 outputs, as a detection potential signal VX, a signal corresponding to residual vibration generated in the discharge section D to be inspected, to the detection circuit 23, and the detection circuit 23 acquires the detection potential signal VX, generates a detection signal SK in accordance with the acquired detection potential signal VX, and outputs the detection signal SK to the determination circuit 60. Then, the determination circuit 60 determines whether or not the discharge state of the ink in the discharge section D to be inspected is normal based on the detection signal SK, and outputs a state determination signal JH corresponding to the determination result to the control circuit 30. As a result, the control circuit 30 can acquire the state of the discharge section D to be inspected and correct various signals to be output in accordance with the acquired state of the discharge section D to be inspected. As a result, the quality of the image formed on the medium P is improved.

As described above, in the liquid discharge apparatus 1 of the present embodiment, the head unit 5 performs various processes including the discharge process of forming an image corresponding to the image information signal IP on the medium P and the determination process of determining the state of the discharge section D that discharges ink onto the medium P.

In the liquid discharge apparatus 1, the control circuit 30 and the determination circuit 60 may be mounted on a common semiconductor device. At this time, a part or all of the drive circuit 40 and the transport unit 4 may be mounted on the semiconductor device. Further, the supply switching circuit 21 and the detection circuit 23 may be mounted on a common semiconductor device.

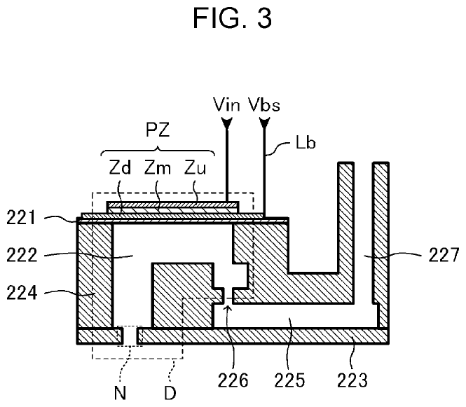

Here, an example of a structure of the discharge section D that discharges the ink to the medium P will be described. FIG. 3 is a diagram illustrating a schematic structure of one discharge section D. As illustrated in FIG. 3, the discharge section D includes a piezoelectric element PZ, a cavity 222 filled with ink, a nozzle N communicating with the cavity 222, and a vibration plate 221. Then, in the discharge section D, the piezoelectric element PZ is driven by supply of the supply drive signal Vin to the piezoelectric element PZ, and the ink stored inside the cavity 222 is discharged from the nozzle N by the drive of the piezoelectric element PZ.

The cavity 222 is a space partitioned by a cavity plate 224, a nozzle plate 223 in which the nozzle N is formed, and the vibration plate 221. The cavity 222 communicates with a reservoir 225 via an ink supply port 226, and the reservoir 225 communicates with the liquid container 3 corresponding to the discharge section D via an ink intake port 227. As a result, the ink is supplied from the corresponding liquid container 3 to the inside of the cavity 222 via the ink intake port 227, the reservoir 225, and the ink supply port 226. Therefore, the ink supplied from the corresponding liquid container 3 is filled in the cavity 222.

The piezoelectric element PZ includes an upper electrode Zu, a lower electrode Zd, and a piezoelectric body Zm. The piezoelectric body Zm is positioned between the upper electrode Zu and the lower electrode Zd. The supply drive signal Vin output by the supply switching circuit 21 is supplied to the upper electrode Zu. In addition, a reference voltage signal Vbs propagated through a wiring line Lb is supplied to the lower electrode Zd. The piezoelectric body Zm is displaced in a vertical direction in FIG. 3 in accordance with a potential difference between the upper electrode Zu and the lower electrode Zd, the potential difference being between a voltage value of the supply drive signal Vin supplied to the upper electrode Zu and a voltage value of the reference voltage signal Vbs supplied to the lower electrode Zd. That is, the piezoelectric element PZ is driven in accordance with the potential difference between the voltage value of the supply drive signal Vin and the voltage value of the reference voltage signal Vbs. Here, the reference voltage signal Vbs supplied to the lower electrode Zd is a signal serving as a reference potential for driving the piezoelectric element PZ, and is a signal having a constant potential such as 5.5 V, 6 V, or a ground potential.

The lower electrode Zd is bonded to the vibration plate 221. Therefore, when the piezoelectric element PZ is driven by the supply drive signal Vin so as to be displaced in the vertical direction in FIG. 3, the vibration plate 221 is also displaced in the vertical direction in FIG. 3. By the displacement of the vibration plate 221, an internal volume and internal pressure of the cavity 222 change. Then, the ink filled in the cavity 222 is discharged from the nozzle N in response to the change in the internal volume and the internal pressure of the cavity 222. That is, the ink in an amount corresponding to the drive amount of the piezoelectric element PZ is discharged from the nozzle N of the discharge section D. In other words, the piezoelectric element PZ discharges the ink in an amount corresponding to the displacement caused by supply of the supply drive signal Vin in accordance with the drive signal Com from the discharge section D. In other words, the print head 25 includes the discharge section D that discharges liquid by driving the piezoelectric element PZ.

### 2 CONFIGURATION OF PRINT HEAD

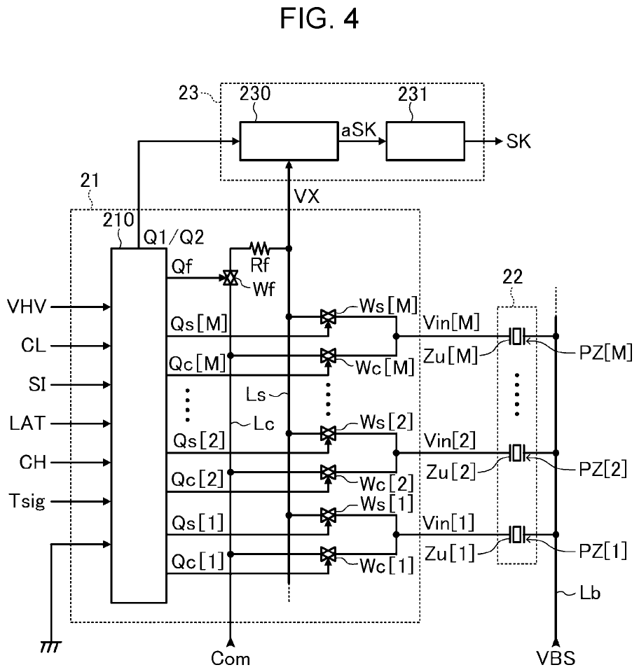

Next, a functional configuration of the print head 25 will be described. FIG. 4 is a diagram illustrating an example of a functional configuration of the print head 25. As described above, the print head 25 includes the supply switching circuit 21, the recording head 22, and the detection circuit 23. In addition, in FIG. 4, in the print head 25, a wiring line Lc through which the drive signal Com propagates, the wiring line Lb through which the reference voltage signal Vbs propagates, and a wiring line Ls through which the detection potential signal VX propagates to the detection circuit 23 are illustrated.

The supply switching circuit 21 includes switches Wc[1] to Wc[M], switches Ws[1] to Ws[M], a switch Wf, a resistor Rf, and a coupling state designation circuit 210. The switches Wc[1] to Wc[M] and the switches Ws[1] to Ws[M] are provided in correspondence with the discharge sections D[1] to D[M] in the supply switching circuit 21. Specifically, in the supply switching circuit 21, the switch Wc[m] and the switch Ws[m] are provided in correspondence with the discharge section D[m].

The print head 25 receives the power supply voltage signal VHV, the clock signal CL, the print data signal SI, the latch signal LAT, the change signal CH, and the period designation signal Tsig. The power supply voltage signal VHV, the clock signal CL, the print data signal SI, the latch signal LAT, the change signal CH, and the period designation signal Tsig are input to the coupling state designation circuit 210.

The coupling state designation circuit 210 generates a signal for designating a conductive state of each of the switches Wc[1] to Wc[M], the switches Ws[1] to Ws[M], and the switch Wf according to the print data signal SI propagated in synchronization with the clock signal CL in each of the periods defined by the input latch signal LAT, the change signal CH, and the period designation signal Tsig. Thereafter, the coupling state designation circuit 210 outputs coupling state designation signals Qc[1] to Qc[M] by level-shifting the signals for designating the conductive states of the switches Wc[1] to Wc[M] to high amplitude logic signals of the voltage value of the power supply voltage signal VHV, outputs coupling state designation signals Qs[1] to Qs[M] by level-shifting the signals for designating the conductive states of the switches Ws[1] to Ws[M] to high amplitude logic signals of the voltage value of the power supply voltage signal VHV, and outputs a coupling state designation signal Qf by level-shifting the signal for designating the conductive state of the switch Wf to a high amplitude logic signal of the voltage value of the power supply voltage signal VHV. That is, the coupling state designation circuit 210 generates and outputs the coupling state designation signals Qc[1] to Qc[M], Qs[1] to Qs[M], and Qf in which an H level is the power supply voltage signal VHV and an L level is a ground potential.

The coupling state designation signals Qc[1] to Qc[M] output by the coupling state designation circuit 210 are input to control terminals of the switches Wc[1] to Wc[M], the coupling state designation signals Qs[1] to Qs[M] output by the coupling state designation circuit 210 are input to control terminals of the switches Ws[1] to Ws[M], and the coupling state designation signal Qf output by the coupling state designation circuit 210 is input to a control terminal of the switch Wf. As a result, the conductive state of each of the switches Wc[1] to Wc[M], Ws[1] to Ws[M], and Wf are controlled.

The coupling state designation circuit 210 includes, for example, a register that holds the print data signal SI propagated in synchronization with the clock signal CL in correspondence with the discharge sections D[1] to D[M], a decoder that decodes the print data signal SI held in the register to generate a signal for designating the conductive state of the switches Wc[1] to Wc[M], Ws[1] to Ws[M], and Wf, and a level shift circuit that outputs the coupling state designation signals Qc[1] to Qc[M], Qs[1] to Qs[M], Qf, and the like, obtained by level-shifting the logic of the signal generated by the decoder to the high amplitude logic signal of the voltage value of the power supply voltage signal VHV.

Among the switches Wc[1] to Wc[M], a switch Wc[m] has one end electrically coupled to the wiring line Lc and the other end electrically coupled to the upper electrode Zu[m] of the piezoelectric element PZ[m] included in the discharge section D[m]. The coupling state designation signal Qc[m] among the coupling state designation signals Qc[1] to Qc[M] is input to the control terminal of the switch Wc[m]. The switch Wc[m] switches the conductive state between one end and the other end according to the logic level of the coupling state designation signal Qc[m] input to the control terminal. That is, the switch Wc[m] switches a coupling state between the wiring line Lc and the upper electrode Zu[m] in accordance with the logic level of the coupling state designation signal Qc[m] input to the control terminal. As a result, the switch Wc[m] switches whether or not to supply the drive signal Com propagating through the wiring line Lc to the upper electrode Zu[m] of the discharge section D[m] as the supply drive signal Vin[m] according to the coupling state designation signal Qc[m]. In other words, the switch Wc[m] is capable of switching between conduction and non-conduction between the drive circuit 40 that outputs the drive signal Com and the discharge section D[m].

Among the switches Ws[1] to Ws[M], a switch Ws[m] has one end electrically coupled to the wiring line Ls and the other end electrically coupled to the upper electrode Zu[m] of the piezoelectric element PZ[m] included in the discharge section D[m]. The coupling state designation signal Qs[m] among the coupling state designation signals Qs[1] to Qs[M] is input to the control terminal of the switch Ws[m]. The switch Ws[m] switches the conductive state between one end and the other end according to the logic level of the coupling state designation signal Qs[m] input to the control terminal. That is, the switch Ws[m] switches a coupling state between the wiring line Ls and the upper electrode Zu[m] in accordance with the logic level of the coupling state designation signal Qs[m] input to the control terminal. As a result, the switch Ws[m] switches whether or not to supply the signal generated in the upper electrode Zu[m] of the piezoelectric element PZ[m] to the wiring line Ls in response to the coupling state designation signal Qs[m] according to the residual vibration generated in the discharge section D[m]. In other words, the switch Ws[m] is capable of switching between conduction and non-conduction between the discharge section D [m] and the detection circuit 23 coupled to the wiring line Ls.

One end of the switch Wf is electrically coupled to the wiring line Lc, and the other end thereof is electrically coupled to one end of the resistor Rf. Further, the other end of the resistor Rf is electrically coupled to the wiring line Ls. That is, the one end of the switch Wf is electrically coupled to the wiring line Lc, and the other end is electrically coupled to the wiring line Ls via the resistor Rf. The coupling state designation signal Qf is input to the control terminal of the switch Wf. The switch Wf switches the conductive state between one end and the other end according to the logic level of the coupling state designation signal Qf input to the control terminal. That is, the switch Wf switches the coupling state between the wiring line Lc and the wiring line Ls in accordance with the logic level of the coupling state designation signal Qf input to the control terminal.

As described above, the supply switching circuit 21 includes the switches Ws[1] to Ws [M] that switch whether or not to supply the detection potential signal VX to the detection circuit 23, and the switches Wc [1] to Wc [M] that switch whether or not to supply the drive signal Com to the discharge sections D[1] to D[M]. The switches Ws[1] to Ws[M] switch whether or not to supply the detection potential signal VX to the detection circuit 23 based on the coupling state designation signals Qs[1] to Qs[M] corresponding to the power supply voltage signal VHV, and the switches Wc[1] to Wc[M] switch whether or not to supply the drive signal Com to the piezoelectric elements PZ[1] to PZ[m] based on the coupling state designation signals Qc[1] to Qc[M] corresponding to the power supply voltage signal VHV. That is, the power supply voltage signal VHV output from the power supply circuit 50a is supplied to the switches Wc[1] to Wc[M] and Ws[1] to Ws[M].

Each of the switches Wc[1] to Wc[M] and Ws[1] to Ws[M] as described above can be configured with, for example, a transmission gate. Here, an example of the configuration of the transmission gates constituting the switches Wc[1] to Wc[M] and Ws[1] to Ws[M] will be described. The switches Wc[1] to Wc[M] and Ws[1] to Ws[M] have the same configuration except that input signals and output signals are different. Therefore, in the following description, the switches Wc[1] to Wc[M] and Ws[1] to Ws[M] will be simply referred to as a switch W without distinction. At this time, one end of the switch W is electrically coupled to a wiring line L serving as the wiring line Lc through which the drive signal Com is propagated or the wiring line Ls through which the detection potential signal VX is propagated, the other end of the switch W is electrically coupled to the upper electrode Zu of the piezoelectric element PZ included in the discharge section D as the discharge sections D[1] to D[M], and the coupling state designation signal Q as the coupling state designation signals Qc[1] to Qc[M] and Qs[1] to Qs[M] is input to the control terminal of the switch W.

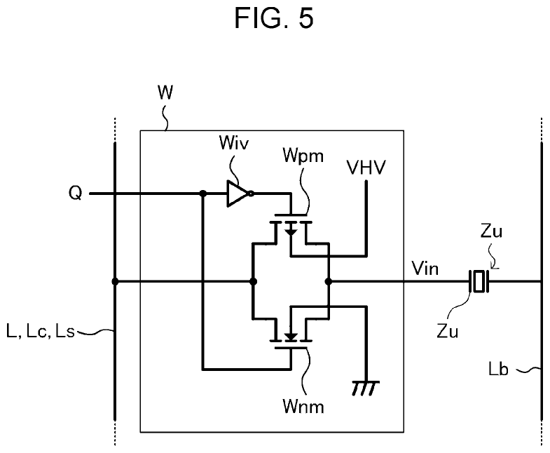

FIG. 5 is a diagram illustrating an example of a configuration of the switch W. As illustrated in FIG. 5, the switch W includes a transistor Wnm that is an n-channel type MOS-FET, a transistor Wpm that is a p-channel type MOS-FET, and an inverter Wiv.

One end of the transistor Wnm and one end of the transistor Wpm are electrically coupled to each other, and the other end of the transistor Wnm and the other end of the transistor Wpm are electrically coupled to each other. Here, the one end of the transistor Wnm corresponds to a drain terminal of the switches Wc[1] to Wc[M] and corresponds to a source terminal of the switches Ws[1] to Ws[M], the other end of the transistor Wnm corresponds to a source terminal of the switches Wc[1] to Wc[M] and corresponds to a drain terminal of the switches Ws[1] to Ws[M], the one end of the transistor Wpm corresponds to a source terminal of the switches Wc[1] to Wc[M] and corresponds to a drain terminal of the switches Ws[1] to Ws[M], and the other end of the transistor Wpm corresponds to a drain terminal of the switches Wc[1] to Wc[M] and corresponds to a source terminal of the switches Ws[1] to Ws[M].

A coupling point where the one end of the transistor Wnm and the other end of the transistor Wpm are coupled to each other is electrically coupled to the wiring line L, and a coupling point where the other end of the transistor Wnm and the other end of the transistor Wpm are coupled to each other is electrically coupled to the upper electrode Zu of the piezoelectric element PZ. That is, the coupling point where the one end of the transistor Wnm and the other end of the transistor Wpm are coupled to each other corresponds to one end of the switch W, and the coupling point where the other end of the transistor Wnm and the other end of the transistor Wpm are coupled to each other corresponds to the other end of the switch W.

The coupling state designation signal Q is input to a gate terminal of the transistor Wnm, and a signal in which a logic level of the coupling state designation signal Q is inverted is input to the gate terminal of the transistor Wpm via the inverter Wiv. That is, conduction states of the transistor Wnm and the transistor Wpm are controlled by the coupling state designation signal Q based on the power supply voltage signal VHV.

In addition, the ground potential is supplied to a back gate terminal of the transistor Wnm, and the power supply voltage signal VHV is supplied to a back gate terminal of the transistor Wpm.

In the switch W configured as described above, when the coupling state designation signal Q having the H level is input, conduction between one end and the other end of the transistor Wnm and between one end and the other end of the transistor Wpm is controlled, and when the coupling state designation signal Q having the L level is input, non-conduction between the one end and the other end of the transistor Wnm and between the one end and the other end of the transistor Wpm is controlled. That is, when the coupling state designation signal Q having the H level is input to the control terminal of the switch W, one end and the other end of the switch W are controlled to be in a conductive state, and when the coupling state designation signal Q having the L level is input to the control terminal of the switch W, the one end and the other end of the switch W are controlled to be in a non-conductive state.

The switch W may be configured to receive the coupling state designation signal Q at the gate terminal of the transistor Wpm and receive a signal in which the logic level of the coupling state designation signal Q is inverted at the gate terminal of the transistor Wnm via the inverter Wiv. In this case, when the coupling state designation signal Q having the L level is input to the control terminal of the switch W, one end and the other end of the switch W may be controlled to be in a conductive state, and when the coupling state designation signal Q having the H level is input to the control terminal of the switch W, the one end and the other end of the switch W may be controlled to be in a non-conductive state.

That is, the switches Wc[1] to Wc [M] include transistors Wnm and Wpm that switch whether or not to supply the drive signal Com to the piezoelectric elements PZ[1] to PZ[M], and the power supply voltage signal VHV is supplied to the back gate terminal of the transistor Wpm. In addition, the switches Ws[1] to Ws[M] include transistors Wnm and Wpm which switch whether or not to supply the detection potential signal VX to the detection circuit 23, and the power supply voltage signal VHV is supplied to the back gate terminal of the transistor Wpm.

Returning back to FIG. 4, the coupling state designation circuit 210 generates coupling state designation signals Q1 and Q2 in accordance with the print data signal SI propagated based on the clock signal CL in the periods defined by the input latch signal LAT, change signal CH, and period designation signal Tsig, and outputs the coupling state designation signals to the detection circuit 23.

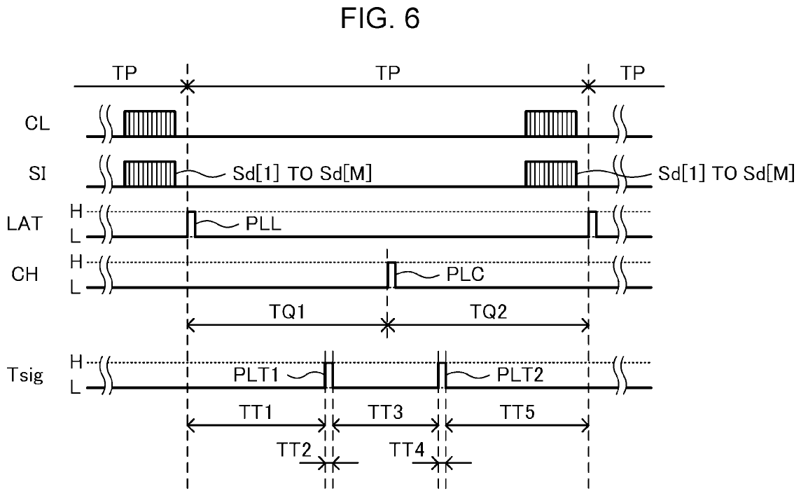

Here, an example of various signals input to the coupling state designation circuit 210 will be described. FIG. 6 is a diagram for explaining an example of various signals input to the coupling state designation circuit 210. As illustrated in FIG. 6, the liquid discharge apparatus 1 of the present embodiment defines one or a plurality of unit periods TP as an operation period, and controls the drive of the discharge section D[m] and the operation of the detection circuit 23 in each of the defined unit periods TP.

Specifically, the control circuit 30 generates the latch signal LAT including a pulse PLL and outputs the latch signal LAT to the coupling state designation circuit 210. For example, the control circuit 30 may generate the latch signal LAT including the pulse PLL by setting the logic level of the latch signal LAT to the H level for a short time at a timing based on a transport position of the medium P transported along the transport direction, and may output the latch signal LAT to the coupling state designation circuit 210. Further, for example, the control circuit 30 may generate the latch signal LAT including the pulse PLL by setting the logic level of the latch signal LAT to the H level for a short time at a predetermined time interval, and may output the latch signal LAT to the coupling state designation circuit 210. The period from the rise of the pulse PLL included in the latch signal LAT to the next rise of the pulse PLL corresponds to the above-described unit period TP.

Further, the control circuit 30 generates the change signal CH including a pulse PLC and outputs the change signal CH to the coupling state designation circuit 210. For example, the control circuit 30 generates the change signal CH including the pulse PLC by setting the logic level of the change signal CH to the H level for a short time at a timing when a predetermined time has elapsed from the rise of the pulse PLL, and outputs the change signal CH to the coupling state designation circuit 210. The pulse PLC included in the change signal CH divides the unit period TP into a control period TQ1 and a control period TQ2. Specifically, the change signal CH divides the unit period TP into the control period TQ1, which is a period from the rise of the pulse PLL to the rise of the pulse PLC, and the control period TQ2, which is a period from the rise of the pulse PLC to the rise of the pulse PLL. The number of divisions of the unit period TP by the change signal CH is not limited to two.

The control circuit 30 generates the period designation signal Tsig including pulses PLT1 and PLT2, and outputs the period designation signal Tsig to the coupling state designation circuit 210. For example, the control circuit 30 sets the logic level of the period designation signal Tsig to the H level at a timing at which a predetermined time has elapsed from the rise of the pulse PLL, then sets the logic level of the period designation signal Tsig to the L level to generate the pulse PLT1, and outputs the pulse PLT1 to the coupling state designation circuit 210. Further, the control circuit 30 sets the logic level of the period designation signal Tsig to the H level at a timing at which a predetermined time has elapsed after the pulse PLT1 is generated, and then sets the logic level of the period designation signal Tsig to the L level to generate the pulse PLT2 and output the pulse PLT2 to the coupling state designation circuit 210. The pulses PLT1 and PLT2 included in the period designation signal Tsig divide the unit period TP into control periods TT1 to TT5. Specifically, the unit period TP is divided by the period designation signal Tsig into a control period TT1, which is a period from the rise of the pulse PLL to the rise of the pulse PLT1, a control period TT2, which is a period from the rise of the pulse PLT1 to the fall of the pulse PLT1, a control period TT3, which is a period from the fall of the pulse PLT1 to the rise of the pulse PLT2, a control period TT4, which is a period from the rise of the pulse PLT2 to the fall of the pulse PLT2, and a control period TT5, which is a period from the fall of the pulse PLT2 to the rise of the pulse PLL. The number of divisions of the unit period TP by the period designation signal Tsig is not limited to five.

Further, the control circuit 30 generates the print data signal SI serially including individual designation signals Sd[1] to Sd[M] and outputs the print data signal SI to the coupling state designation circuit 210. The individual designation signals Sd[1] to Sd[M] are signals each including 3-bit information and define the drive mode of each of the discharge sections D[1] to D[M]. Here, in the following description, the 3-bit information included in the individual designation signal Sd[m] may be referred to as bits S1, S2, and S3, and the individual designation signal Sd[m] may be expressed as Sd[m]=[S1, S2, S3]. Further, in the following description, when the bits S1, S2, and S3 included in the individual designation signal SD[m] may be either “1” or “0”, the case may be expressed using “*”.

Specifically, the control circuit 30 generates the print data signal SI including the individual designation signals Sd[1] to Sd[M] that define the drive mode of the discharge sections D[1] to D[M] and the operation of the detection circuit 23 in the unit period TP to be controlled, prior to the unit period TP to be controlled, and outputs the print data signal SI to the coupling state designation circuit 210. The print data signal SI is held in a register (not illustrated) in the coupling state designation circuit 210 in a state in which the individual designation signals Sd[1] to Sd[M] correspond to the discharge sections D[1] to D[M], respectively. Then, when the unit period TP becomes a control target, the coupling state designation circuit 210 simultaneously latches 3-bit information included in each of the individual designation signals Sd[1] to Sd[M] held therein, and by decoding the latched 3-bit information, generates the coupling state designation signals Qc[1] to Qc[M], Qs[m] to Qs[M], Qf, Q1, and Q2 having logic levels according to decoded contents in each of control periods TQ1 and TQ2 among the unit period TP to be controlled or in each of control periods TT1 to TT5, and outputs the coupling state designation signals to control terminals of corresponding switches Wc[1] to Wc[M], Ws[1] to Ws[M], Wf, W1, and W2.

As a result, the conduction state of each of the switches Wc[1] to Wc[M], Ws[1] to Ws[M], Wf, W1, and W2 in each of the control periods TQ1 and TQ2 or each of the control periods TT1 to TT5 is controlled. As a result, the drive mode of the discharge sections D[1] to D[M] and the operation of the detection circuit 23 in each of the control periods TQ1 and TQ2 or each of the control periods TT1 to TT5 is controlled.

Returning to FIG. 4, the detection potential signal VX propagating through the wiring line Ls and the coupling state designation signals Q1 and Q2 output by the coupling state designation circuit 210 are input to the detection circuit 23. The detection circuit 23 includes a waveform shaping circuit 230 and an AD conversion circuit 231. The waveform shaping circuit 230 acquires the detection potential signal VX in accordance with the coupling state designation signals Q1 and Q2. The waveform shaping circuit 230 removes noise from the acquired detection potential signal VX and amplifies the detection potential signal VX to shape a signal waveform of the detection potential signal VX and output the shaped signal waveform as a detection signal aSK. The AD conversion circuit 231 converts the detection signal aSK, which is an analog signal output by the waveform shaping circuit 230, into a digital signal and outputs the digital signal as the detection signal SK. The detection signal SK is output from the detection circuit 23 and the print head 25. That is, the detection circuit 23 changes the signal corresponding to the residual vibration generated in the discharge section D into the digital signal and outputs the digital signal as the detection signal SK.

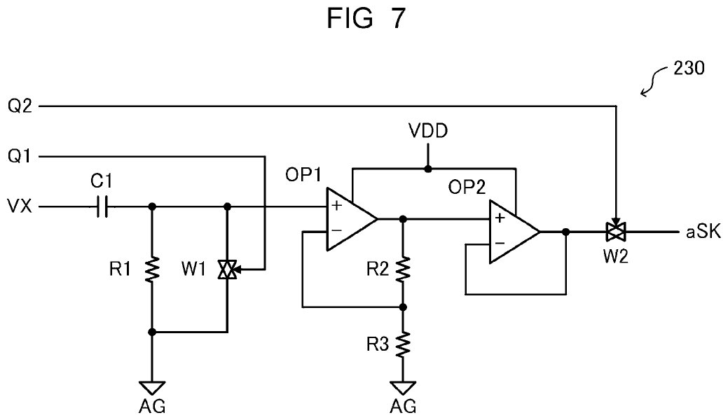

Here, an example of a configuration of the waveform shaping circuit 230 will be described. FIG. 7 is a diagram illustrating an example of a configuration of the waveform shaping circuit 230. As illustrated in FIG. 7, the waveform shaping circuit 230 includes a capacitor C1, operational amplifiers OP1 and OP2, switches W1 and W2, and resistors R1 to R3.

The detection potential signal VX output by the supply switching circuit 21 is input to one end of the capacitor C1. The other end of the capacitor C1 is electrically coupled to one end of the resistor R1 and one end of the switch W1. An analog ground AG fixed to a constant potential is supplied to the other end of the resistor R1 and the other end of the switch W1. That is, the resistor R1 and the switch W1 are coupled in parallel. The coupling state designation signal Q1 is input to the control terminal of the switch W1. When the coupling state designation signal Q1 having the H level is input to the control terminal, the switch W1 becomes conductive between one end and the other end, and when the coupling state designation signal Q1 having the L level is input to the control terminal, the switch W1 becomes non-conductive between the one end and the other end. That is, the switch W1 switches the conductive state between the one end of the resistor R1 and the analog ground AG. The capacitor C1, the resistor R1, and the switch W1 configured as described above function as a high-pass filter, and extract and output a signal of a predetermined high frequency component from the detection potential signal VX input in a period during which the switch W1 is controlled to be non-conductive. Here, the switch W1 may be configured with, for example, a transmission gate as illustrated in FIG. 5.

A power supply voltage signal VDD is supplied to the power supply terminal of the operational amplifier OP1. A +side input terminal of the operational amplifier OP1 is electrically coupled to a coupling point where the other end of the capacitor C1, the one end of the resistor R1, and the one end of the switch W1 are electrically coupled. That is, a signal output by the high-pass filter including the capacitor C1, the resistor R1, and the switch W1 is input to the +side input terminal of the operational amplifier OP1. A −side input terminal of the operational amplifier OP1 is electrically coupled to a coupling point where the one end of the resistor R2 and the one end of the resistor R3 are electrically coupled. An output terminal of the operational amplifier OP1 is electrically coupled to the other end of the resistor R2. The analog ground AG is supplied to the other end of the resistor R3. That is, the operational amplifier OP1 and the resistors R2 and R3 function as a non-inverting amplifier circuit that amplifies a signal input to the +side input terminal of the operational amplifier OP1 according to resistance values of the resistors R2 and R3 and that outputs the signal from the output terminal of the operational amplifier OP1. Here, the non-inverting amplifier circuit including the operational amplifier OP1 and the resistors R2 and R3 may be configured to output an amplified signal after superimposing a predetermined offset voltage on a signal output from the high-pass filter configured with the capacitor C1, the resistor R1, and the switch W1.

A power supply voltage signal VDD is supplied to the power supply terminal of the operational amplifier OP2. The output terminal of the operational amplifier OP1 is electrically coupled to the +side input terminal of the operational amplifier OP2. That is, a signal output by the non-inverting amplifier circuit configured with the operational amplifier OP1 and the resistors R2 and R3 is input to the +side input terminal of the operational amplifier OP2. The −side input terminal of the operational amplifier OP2 is electrically coupled to the output terminal of the operational amplifier OP2. That is, the operational amplifier OP2 constitutes a voltage follower circuit. As a result, the operational amplifier OP2 converts an impedance of the signal output from the non-inverting amplifier circuit configured with the operational amplifier OP1 and the resistors R2 and R3, and outputs the signal.

One end of the switch W2 is electrically coupled to the output terminal of the operational amplifier OP2. The signal at the other end of the switch W2 is output, as the detection signal aSK, from the waveform shaping circuit 230. In addition, the coupling state designation signal Q2 is input to the control terminal of the switch W2. When the coupling state designation signal Q2 having the H level is input to the control terminal, the switch W2 becomes conductive between one end and the other end, and when the coupling state designation signal Q2 having the L level is input to the control terminal, the switch W2 becomes non-conductive between the one end and the other end. The switch W2 switches whether or not to output the signal output by the operational amplifier OP2, as the detection signal aSK, from the waveform shaping circuit 230 according to the logic level of the coupling state designation signal Q2 input to the control terminal.

As described above, the waveform shaping circuit 230 removes noise components from the detection potential signal VX by the high-pass filter including the capacitor C1, the resistor R1, and the switch W1, and amplifies the signal from which the noise component is removed by the non-inverting amplifier circuit including the operational amplifier OP1, and the resistors R2 and R3. The waveform shaping circuit 230 outputs the detection signal aSK after performing impedance conversion by a voltage follower circuit including the operational amplifier OP2. At this time, the switches W1 and W2 switch whether or not the waveform shaping circuit 230 acquires the detection potential signal VX and outputs it as the detection signal aSK.

Then, the detection signal aSK output by the waveform shaping circuit 230 is input to the AD conversion circuit 231. The AD conversion circuit 231 converts the detection signal aSK into a digital signal. The signal converted into digital by the AD conversion circuit 231 is output from the detection circuit 23 and the print head 25 as the detection signal SK.

As described above, the detection circuit 23 includes the waveform shaping circuit 230 and the AD conversion circuit 231, is supplied with the power supply voltage signal VDD held at a constant voltage, and detects the residual vibration generated in the discharge section D to be discharged due to the discharge of the ink using the operational amplifiers OP1 and OP2 capable of outputting the signal according to the input signal. The detection circuit 23 may include a plurality of operational amplifiers of any number, in addition to the operational amplifiers OP1 and OP2 or instead of the operational amplifiers OP1 and OP2, and each of the plurality of operational amplifiers may be supplied with the power supply voltage signal VDD and be capable of outputting a signal corresponding to an input signal.

In the print head 25 of the present embodiment configured as described above, the supply switching circuit 21 controls a conductive state of the switch Wc[m] according to the print data signal SI propagated based on the clock signal CL in each of the control periods TQ1 and TQ2 or each of the control periods TT1 to TT5 defined by the latch signal LAT, the change signal CH, and the period designation signal Tsig, thereby switching whether or not to supply the drive signal Com propagating through the wiring line Ls, as a supply drive signal Vin[m], to the piezoelectric element PZ[m] of the discharge section D[m]. As a result, the drive mode of the discharge section D[m] is controlled.

In addition, in the print head 25 of the present embodiment, the supply switching circuit 21 controls the conductive state of the switch Ws[m] according to the print data signal SI propagated based on the clock signal CL in each of the control periods TQ1 and TQ2 or each of the control periods TT1 to TT5 defined by the latch signal LAT, the change signal CH, and the period designation signal Tsig, thereby switching whether or not to acquire the signal according to the residual vibration generated in the discharge section D[m] and output the signal to the detection circuit 23 as the detection potential signal VX. At this time, the detection circuit 23 amplifies and shapes the signal waveform of the input detection potential signal VX according to the conductive states of the switches W1 and W2, and outputs the signal waveform as the detection signal SK.

That is, when the piezoelectric element PZ is displaced in response to the residual vibration generated in the discharge section D, the detection circuit 23 acquires the electromotive force generated in the piezoelectric element PZ as the detection potential signal VX and outputs, as the detection signal SK, a signal corresponding to the acquired detection potential signal VX, the signal being obtained by amplifying and shaping a signal waveform of the acquired detection potential signal VX.

The detection signal SK output by the detection circuit 23 is input to the determination circuit 60. The determination circuit 60 determines a state of the target discharge section D[m] based on the input detection signal SK. That is, the liquid discharge apparatus 1 of the present embodiment includes the determination circuit 60 that determines the state of the discharge section D to be inspected in accordance with the detection signal SK.

Here, the supply switching circuit 21 included in the print head 25 is constituted by one or a plurality of semiconductor devices. In addition, at this time, a part or all of the detection circuit 23 may be mounted on the semiconductor device together with the supply switching circuit 21.

### 3 OPERATION OF PRINT HEAD DURING EXECUTION OF DISCHARGE PROCESS

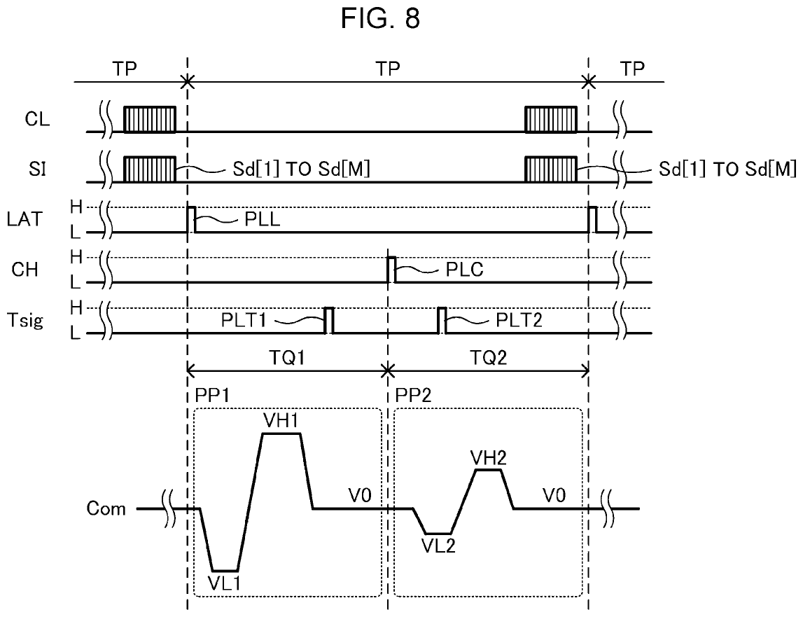

Next, the operation of the print head 25 in a period during which the liquid discharge apparatus 1 executes a discharge process of forming an image corresponding to the image information signal IP on the medium P will be described. FIG. 8 is a diagram for explaining an example of various signals output by the control circuit 30 in a period during which a discharge process is executed.

The control circuit 30 generates the drive waveform designation signal dCom that defines a signal waveform of the drive signal Com output by the drive circuit 40 in a period during which the discharge process is executed, and outputs the drive waveform designation signal dCom to the drive circuit 40. The drive circuit 40 generates the drive signal Com having a signal waveform in which a drive waveform PP1 disposed in the control period TQ1 and a drive waveform PP2 disposed in the control period TQ2 are continuous for each unit period TP as illustrated in FIG. 8, according to the input drive waveform designation signal dCom, and supplies the drive signal Com to the print head 25.

The drive waveform PP1 is a signal waveform in which a voltage value starts at a reference potential V0, changes to a potential VL1 lower than the reference potential V0, then changes to a potential VH1 higher than the reference potential V0, and thereafter ends at the reference potential V0. When the drive waveform PP1 is supplied to the piezoelectric element PZ[m], the piezoelectric element PZ[m] is driven such that ink in an ink amount 1 is discharged from the nozzle N[m]. That is, the drive waveform PP1 is a signal waveform for discharging the ink in the ink amount 1 from the nozzle N[m].

The drive waveform PP2 is a signal waveform in which a voltage value starts at a reference potential V0, changes to a potential VL2 lower than the reference potential V0, then changes to a potential VH2 higher than the reference potential V0, and thereafter ends at the reference potential V0. When the drive waveform PP2 is supplied to the piezoelectric element PZ[m], the piezoelectric element PZ[m] is driven such that the ink in an ink amount 2 that is smaller than the ink amount 1 is discharged from the nozzle N[m]. That is, the drive waveform PP2 is a signal waveform for discharging the ink in the ink amount 2 from the nozzle N[m].

Here, in the liquid discharge apparatus 1 of the present embodiment, multi-gradation dots are formed on the medium P by selecting to form any one of a large dot, a medium dot smaller than the large dot, or a small dot smaller than the medium dot, or not to form the dot on the medium P for each unit period TP in the period during which the discharge process is executed. That is, the liquid discharge apparatus 1 of the present embodiment selects whether to discharge ink in any one of amounts corresponding to the large dot, the medium dot, and the small dot, or not to discharge ink from the discharge section D[m] for each unit period TP in the period during which the discharge process is executed. At this time, in the liquid discharge apparatus 1 of the present embodiment, description will be made on the assumption that the ink amount 1 discharged from the discharge section D[m] when the drive waveform PP1 is supplied to the piezoelectric element PZ[m] is an ink amount corresponding to the medium dot, the ink amount 2 discharged from the discharge section D[m] when the drive waveform PP2 is supplied to the piezoelectric element PZ[m] is an ink amount corresponding to the small dot, and the total amount of the ink amount 1 and the ink amount 2 is an ink amount corresponding to the large dot.

Further, in the period during which the liquid discharge apparatus 1 of the present embodiment executes the discharge process, the individual designation signal Sd[m] input to the coupling state designation circuit 210 defines the conduction state of the switch Wc[m] in each of the control periods TQ1 and TQ2 to control whether to supply the supply drive signal Vin[m] including the drive waveform PP1 disposed in the control period TQ1 and the drive waveform PP2 disposed in the control period TQ2 to the discharge section D[m], whether to supply the supply drive signal Vin[m] including the drive waveform PP1 disposed in the control period TQ1 to the discharge section D[m], whether to supply the supply drive signal Vin[m] including the drive waveform PP2 disposed in the control period TQ2 to the discharge section D[m], or whether to supply the supply drive signal Vin[m] including neither the drive waveform PP1 disposed in the control period TQ1 nor the drive waveform PP2 disposed in the control period TQ2 to the discharge section D[m], for each unit period TP. As a result, in the unit period TP during which the liquid discharge apparatus 1 executes the discharge process, whether to discharge the ink in an amount corresponding to the large dot, whether to discharge the ink in an amount corresponding to the medium dot, whether to discharge the ink in an amount corresponding to the small dot, or whether to discharge no ink from the discharge section D[m] is controlled. As a result, a dot size formed on the medium P is controlled.

Here, a relationship between the individual designation signals Sd[1] to Sd[M] included in the print data signal SI input to the coupling state designation circuit 210 and the coupling state designation signals Qc[1] to Qc[M] and Qs[1] to Qs[M] output by the coupling state designation circuit 210 in a period during which the liquid discharge apparatus 1 executes the discharge process will be described as an example of decoding contents of the individual designation signals Sd[1] to Sd[M] executed in the coupling state designation circuit 210.

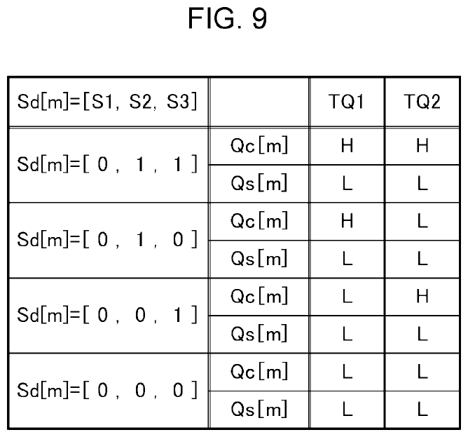

FIG. 9 is a diagram illustrating an example of the relationship between the individual designation signal Sd[m] and the coupling state designation signals Qc[m] and Qs[m]in the period during which the discharge process is executed.

As illustrated in FIG. 9, when the individual designation signal Sd[m]=[0, 1, 1] is input to the coupling state designation circuit 210, the coupling state designation circuit 210 generates the coupling state designation signal Qc[m] that is at an H level in the control period TQ1 and is at an H level in the control period TQ2, and outputs the coupling state designation signal Qc[m] to the control terminal of the switch Wc[m]. As a result, the switch Wc[m] is controlled to be conductive in the control period TQ1 and is controlled to be conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is supplied to the piezoelectric element PZ[m] in the control period TQ2. As a result, the ink in the ink amount 1 is discharged from the nozzle N[m] in the control period TQ1, and the ink in the ink amount 2 is discharged from the nozzle N[m] in the control period TQ2. Then, the ink in the ink amount 1 discharged in the control period TQ1 and the ink in the ink amount 2 discharged in the control period TQ2 land on the medium P and are combined with each other, and thus a large dot is formed on the medium P in the unit period TP.

Further, when the individual designation signal Sd[m]=[0, 1, 0] is input to the coupling state designation circuit 210, the coupling state designation circuit 210 generates the coupling state designation signal Qc[m] that is at an H level in the control period TQ1 and is at an L level in the control period TQ2, and outputs the coupling state designation signal Qc[m] to the control terminal of the switch Wc[m]. As a result, the switch Wc[m] is controlled to be conductive in the control period TQ1 and controlled to be non-conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ2 in which the supply drive signal Vin[m] including the drive waveform PP2 is not supplied to the piezoelectric element PZ[m], in the upper electrode Zu[m], the reference potential V0, which is a voltage value of the signal supplied immediately before to the upper electrode Zu[m], is held by a capacitive component of the piezoelectric element PZ[m]. That is, in the control period TQ2 in which the supply drive signal Vin[m] including the drive waveform PP2 is not supplied to the piezoelectric element PZ[m], a constant signal at the reference potential V0 is supplied to the upper electrode Zu[m]. As a result, the ink in the ink amount 1 is discharged from the nozzle N[m] in the control period TQ1, and the ink is not discharged in the control period TQ2. Then, the ink in the ink amount 1 discharged in the control period TQ1 lands on the medium P, and thus a medium dot is formed on the medium P in the unit period TP.

Further, when the individual designation signal Sd[m]=[0, 0, 1] is input to the coupling state designation circuit 210, the coupling state designation circuit 210 generates the coupling state designation signal Qc[m] that is at an L level in the control period TQ1 and is at an H level in the control period TQ2, and outputs the coupling state designation signal Qc[m] to the control terminal of the switch Wc[m]. As a result, the switch Wc[m] is controlled to be non-conductive in the control period TQ1 and is controlled to be conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is supplied to the piezoelectric element PZ[m] in the control period TQ2. Here, in the control period TQ1 in which the supply drive signal Vin[m] including the drive waveform PP1 is not supplied to the piezoelectric element PZ[m], in the upper electrode Zu[m], the reference potential V0, which is a voltage value of the signal supplied immediately before to the upper electrode Zu[m], is held by the capacitive component of the piezoelectric element PZ[m]. That is, in the control period TQ1 in which the supply drive signal Vin[m] including the drive waveform PP1 is not supplied to the piezoelectric element PZ[m], a constant signal at the reference potential V0 is supplied to the upper electrode Zu[m]. As a result, the ink is not discharged from the nozzle N[m] in the control period TQ1, and the ink in the ink amount 2 is discharged from the nozzle N[m] in the control period TQ2. Then, the ink in the ink amount 2 discharged in the control period TQ2 lands on the medium P, and thus the small dot is formed on the medium P in the unit period TP.

Further, when the individual designation signal Sd[m]=[0, 0, 0] is input to the coupling state designation circuit 210, the coupling state designation circuit 210 generates the coupling state designation signal Qc[m] that is at an L level in the control period TQ1 and is at an L level in the control period TQ2, and outputs the coupling state designation signal Qc[m] to the control terminal of the switch Wc[m]. As a result, the switch Wc[m] is controlled to be non-conductive in the control period TQ1 and is controlled to be non-conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ1 in which the supply drive signal Vin[m] including the drive waveform PP1 is not supplied to the piezoelectric element PZ[m] and the control period TQ2 in which the supply drive signal Vin[m] including the drive waveform PP2 is not supplied to the piezoelectric element PZ[m], in the upper electrode Zu[m], the reference potential V0, which is a voltage value of the signal supplied immediately before to the upper electrode Zu[m], is held by the capacitive component of the piezoelectric element PZ[m]. That is, in the control period TQ1 in which the supply drive signal Vin[m] including the drive waveform PP1 is not supplied to the piezoelectric element PZ[m], and in the control period TQ2 in which the supply drive signal Vin[m] including the drive waveform PP2 is not supplied, a constant signal at the reference potential V0 is supplied to the upper electrode Zu[m]. As a result, the ink is not discharged from the nozzle N[m] in the control period TQ1, and the ink is not discharged from the nozzle N[m] in the control period TQ2. Therefore, a dot is not formed on the medium P in the unit period TP.

As described above, when the liquid discharge apparatus 1 executes the discharge process, in each of the control periods TQ1 and TQ2 in the unit period TP, the coupling state designation circuit 210 outputs the coupling state designation signals Qc[1] to Qc[M] of logic levels based on the individual designation signals Sd[1] to Sd[M]. As a result, the conductive state of each of the switches Wc[1] to Wc[M] in the control periods TQ1 and TQ2 in the unit period TP is controlled, and the discharge amount of the ink discharged from each of the discharge sections D[1] to D[M] in the control periods TQ1 and TQ2 in the unit period TP is controlled. That is, the dot size formed on the medium P in the unit period TP is controlled. As a result, the liquid discharge apparatus 1 can form an image corresponding to the image information signal IP on the medium P in the period during which the discharge process is executed.

Here, as illustrated in FIG. 9, in the period during which the liquid discharge apparatus 1 executes the discharge process, the coupling state designation circuit 210 continues to output the coupling state designation signal Qs[m] at the L level regardless of the input individual designation signal Sd[m]. Therefore, the switch Ws[m] is controlled to be non-conductive in the period during which the discharge process is being executed. As a result, in the period during which the liquid discharge apparatus 1 executes the discharge process, the upper electrode Zu[m] and the wiring line Ls are not electrically coupled to each other. Therefore, the signal corresponding to the residual vibration generated in the discharge section D[m] is not supplied to the detection circuit 23. Therefore, the detection circuit 23 does not acquire the detection potential signal VX in the period during which the liquid discharge apparatus 1 executes the discharge process. Therefore, although not illustrated, in the period during which the liquid discharge apparatus 1 executes the discharge process, the coupling state designation circuit 210 continues to output the coupling state designation signals Qf, Q1, and Q2 at the L level.

### 4. OPERATION OF PRINT HEAD DURING EXECUTION OF DETERMINATION PROCESS

Next, the determination process of determining a state of the discharge section D that discharges the ink to the medium P will be described. It is known that residual vibration is generated in a discharge section that discharges liquid such as ink by driving a drive element such as a piezoelectric element after the drive element is driven. The residual vibration generated in the discharge section is so-called attenuation vibration in which the amplitude decreases with the passage of time, and waveform information such as the amplitude, the amplitude attenuation rate, the period, and the frequency of the attenuation vibration changes depending on the state of the discharge section. For example, when the viscosity of the liquid stored in the discharge section is changed, the amplitude of the residual vibration generated in the discharge section or the amplitude attenuation rate is changed. When air bubbles are mixed in the discharge section, for example, the frequency of the residual vibration generated in the discharge section increases.

In the liquid discharge apparatus 1 of the present embodiment, in the determination process of determining the state of the discharge section D that discharges the ink to the medium P, the supply switching circuit 21 included in the print head 25 acquires a signal corresponding to the residual vibration generated in the discharge section D[m] to be inspected and outputs the signal to the detection circuit 23 as the detection potential signal VX, and the detection circuit 23 generates a detection signal SK by shaping the signal waveform of the input detection potential signal VX. The determination circuit 60 calculates, based on the input detection signal SK, waveform information such as the amplitude, the period, and the frequency of the detection potential signal VX, that is, waveform information such as the amplitude, the period, and the frequency of the residual vibration generated in the discharge section D[m] to be inspected, and determines a state of the discharge section D[m] to be inspected based on the calculated waveform information. Thereafter, the determination circuit 60 generates a state determination signal JH indicating the determination result and outputs the state determination signal JH to the control circuit 30. As a result, the control circuit 30 can acquire the state of the discharge section D[m] to be inspected, correct the various signals to be output in accordance with the acquired state of the discharge section D[m] to be inspected, or notify a user of the state of the discharge section D[m] to be inspected.

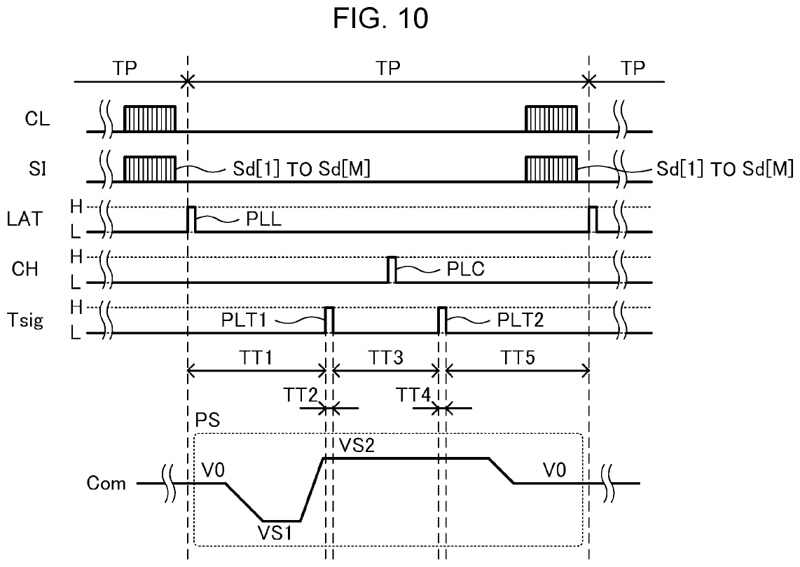

FIG. 10 is a diagram for explaining an example of various signals input to the supply switching circuit 21 of the print head 25 in a period during which a determination process is executed.

The control circuit 30 generates the drive waveform designation signal dCom that defines a signal waveform of the drive signal Com output by the drive circuit 40 in a period during which the determination process is executed, and outputs the drive waveform designation signal dCom to the drive circuit 40. The drive circuit 40 generates the drive signal Com including a drive waveform PS for each unit period TP as illustrated in FIG. 10, in accordance with the input drive waveform designation signal dCom, and supplies the drive signal Com to the print head 25.

The drive waveform PS is a signal waveform in which, in the control period TT1, a voltage value starts at the reference potential V0, changes to a potential VS1 lower than the reference potential V0, then becomes a potential VS2 higher than the reference potential V0, maintains the potential VS2 in the control periods TT2, TT3, and TT4, and in the control period TT5, ends at the reference potential V0. When the drive waveform PS is supplied to the piezoelectric element PZ[m], the piezoelectric element PZ[m] is driven so that ink is not discharged from the nozzle N[m], and after the piezoelectric element PZ[m] is driven, the residual vibration is generated in the discharge section D[m] at the timing when the voltage value of the drive signal Com becomes the potential VS2. That is, the drive waveform PS is a signal waveform for driving the piezoelectric element PZ[m] such that the ink is not discharged from the nozzle N[m] and the predetermined residual vibration is generated in the discharge section D[m], and the piezoelectric element PZ[m] is driven such that the ink is not discharged from the discharge section D[m] and the residual vibration is generated when the drive waveform PS is supplied.

Then, in the period during which the liquid discharge apparatus 1 executes the determination process, the coupling state designation circuit 210 controls the conductive state of each of the switches Wc[1] to Wc[M], Ws[1] to Ws[M], Wf, W1, and W2 based on the individual designation signals Sd[1] to Sd[M] included in the print data signal SI in each of the control periods TT1 to TT5 to supply the supply drive signal Vin[m] including the drive waveform PS to the discharge section D[m] to be inspected, acquires a signal corresponding to the residual vibration generated in the discharge section D[m] to be inspected due to the supply of the supply drive signal Vin[m] including the drive waveform PS, and outputs the acquired signal to the detection circuit 23 as the detection potential signal VX. The detection circuit 23 generates the detection signal SK by shaping the signal waveform of the input detection potential signal VX, and the determination circuit 60 determines a state of the discharge section D[m] to be inspected based on the detection signal SK.

Here, a relationship between the individual designation signals Sd[1] to Sd[M] included in the print data signal SI input to the coupling state designation circuit 210 and the coupling state designation signals Qc[1] to Qc[M], Qs[1] to Qs[M], Qf, Q1, and Q2 output from the coupling state designation circuit 210 in the period during which the liquid discharge apparatus 1 executes the determination process will be described as an example of decoding contents of the individual designation signals Sd[1] to Sd[M] executed in the coupling state designation circuit 210 in the period during which the determination process is executed.

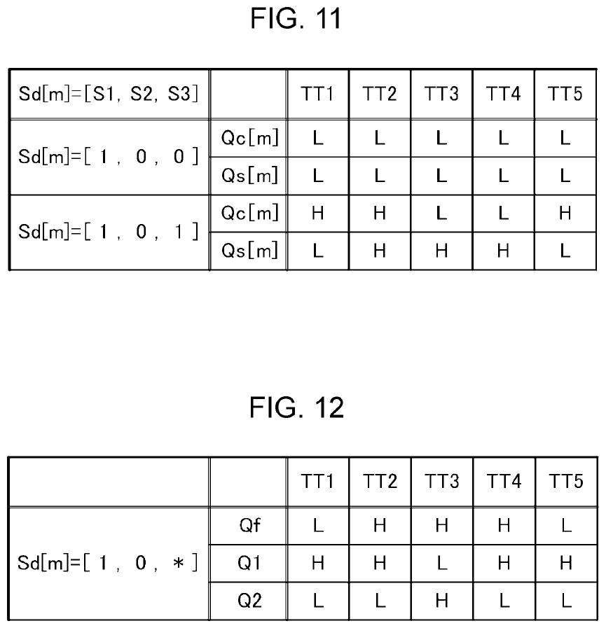

FIG. 11 is a diagram illustrating an example of the relationship between the individual designation signal Sd[m] and the coupling state designation signals Qc[m] and Qs[m] in the period during which the determination process is executed. Here, in the liquid discharge apparatus 1 of the present embodiment, the control circuit 30 outputs the individual designation signal Sd[m]=[1, 0, 0] to the coupling state designation circuit 210 when the discharge section D[m] is not an inspection target in the period during which the determination process is executed, and outputs the individual designation signal Sd[m]=[1, 0, 1] to the coupling state designation circuit 210 when the discharge section D[m] is the inspection target.

Therefore, as illustrated in FIG. 11, when the individual designation signal Sd[m]=[1, 0, 0] is input to the coupling state designation circuit 210, the coupling state designation circuit 210 generates the coupling state designation signal Qc[m] that is at the L level in the control periods TT1 to TT5, outputs the coupling state designation signal Qc[m] to the control terminal of the switch Wc[m], generates the coupling state designation signal Qs[m] that is at the L level in the control periods TT1 to TT5, and outputs the coupling state designation signal Qs[m] to the control terminal of the switch Ws[m]. As a result, the switch Wc[m] is controlled to be non-conductive in the control periods TT1 to TT5, and the switch Ws[m] is controlled to be non-conductive. At this time, the supply drive signal Vin[m] corresponding to the drive signal Com is not supplied to the piezoelectric element PZ[m] of the discharge section D[m] that is not the inspection target. Therefore, the residual vibration is not generated in the discharge section D[m] that is not the inspection target, and in this case, even when the potential of the upper electrode Zu[m] of the piezoelectric element PZ[m] included in the discharge section D[m] that is not the inspection target changes, the signal accompanying the change in the potential is not supplied to the wiring line Ls. Therefore, the determination of the state of the discharge section D[m] that is not the inspection target is not executed.

Further, when the individual designation signal Sd[m]=[1, 0, 1] is input to the coupling state designation circuit 210, the coupling state designation circuit 210 generates the coupling state designation signal Qc[m] that is at the H level in the control periods TT1, TT2, and TT5 and is at the L level in the control periods TT3 and TT4, outputs the coupling state designation signal Qc[m] to the control terminal of the switch Wc[m], generates the coupling state designation signal Qs[m] that is at the H level in the control periods TT2 to TT4 and is at the L level in the control periods TT1 and TT5, and outputs the coupling state designation signal Qs[m] to the control terminal of the switch Ws[m]. As a result, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

FIG. 12 is a diagram illustrating an example of a relationship between the individual designation signal Sd[m] and the coupling state designation signals Qf, Q1, and Q2 in a period during which the determination process is executed. Here, in the period during which the determination process is executed, the coupling state designation circuit 210 outputs the coupling state designation signals Qf, Q1, and Q2 of the same logic level in each of the control periods TT1 to TT5 when the individual designation signal Sd[m]=[1, 0, 0] is input and when the individual designation signal Sd[m]=[1, 0, 1] is input. Therefore, in FIG. 12, the individual designation signal Sd[m]=[1, 0, 0] and the individual designation signal Sd[m]=[1, 0, 1] are collectively illustrated as the individual designation signal Sd[m]=[1, 0, *].

As illustrated in FIG. 12, when the individual designation signal Sd[m]=[1, 0, *] is input to the coupling state designation circuit 210, the coupling state designation circuit 210 generates the coupling state designation signal Qf that is at the H level in the control periods TT2 to TT4 and is at the L level in the control periods TT1 and TT5, outputs the coupling state designation signal Qf to the control terminal of the switch Wf, generates the coupling state designation signal Q1 that is at the H level in the control periods TT1, TT2, TT4, and TT5 and is at the L level in the control period TT3, outputs the coupling state designation signal Q1 to the control terminal of the switch W1, generates the coupling state designation signal Q2 that is at the H level in the control period TT3 and is at the L level in the control periods TT1, TT2, TT4, and TT5, and outputs the coupling state designation signal Q2 to the control terminal of the switch W2. Accordingly, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

Here, in the operation of the liquid discharge apparatus 1 when the individual designation signal Sd[m]=[1, 0, 1] is input to the coupling state designation circuit 210, an example of the acquisition operation in which the detection circuit 23 acquires the detection potential signal VX based on a signal corresponding to the residual vibration generated in the discharge section D[m] to be inspected will be described.

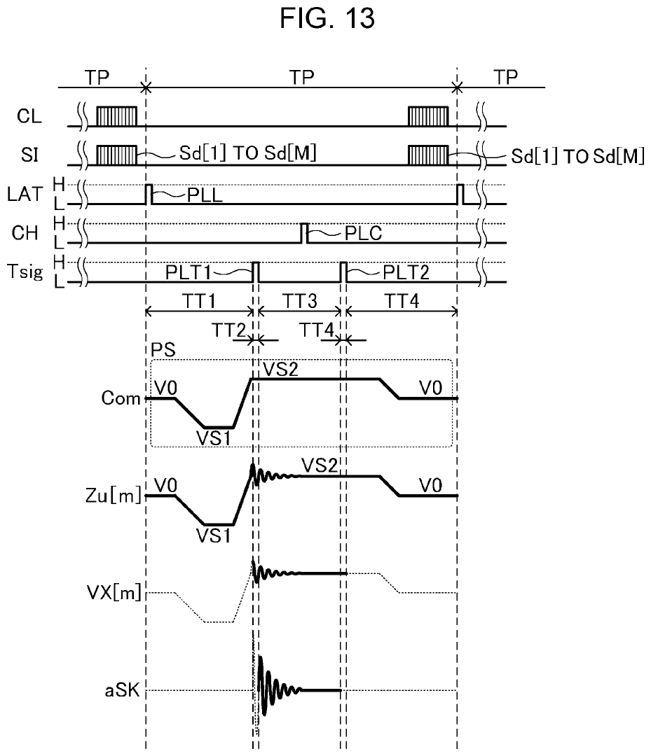

FIG. 13 is a diagram for explaining an example of operation of acquiring the detection potential signal VX based on a signal corresponding to the residual vibration generated in the discharge section D[m] to be inspected. As illustrated in FIG. 13, for each unit period TP in the period during which the determination process is executed, the coupling state designation circuit 210 is supplied with the drive signal Com including the drive waveform PS in which the voltage value starts at the reference potential V0 in the control period TT1, changes to the potential VS1 lower than the reference potential V0, becomes the potential VS2 higher than the reference potential V0, maintains the potential VS2 in the control periods TT2 to TT4, and ends at the reference potential V0 in the control period TT5.

Then, in the period during which the determination process is executed, the control circuit 30 outputs the individual designation signal Sd[m]=[1, 0, 1] corresponding to the discharge section D[m] to be inspected to the coupling state designation circuit 210. At this time, the discharge sections D[1] to D[m−1] and D[m+1] to D[M] are not inspection targets. That is, the control circuit 30 outputs the individual designation signals Sd[1] to Sd[m−1] and Sd[m+1] to Sd[M]=[1, 0, 0] to the coupling state designation circuit 210.

When the print data signal SI including the individual designation signal Sd[m]=[1, 0, 1] and the individual designation signals Sd[1] to Sd[m−1] and Sd[m+1] to Sd[M]=[1, 0, 0] is input to the coupling state designation circuit 210, the switch Wc[m] is controlled to be conductive and the switches Wc[1] to Wc[m−1] and Wc[m+1] to Wc[M] are controlled to be non-conductive in the control periods TT1 and TT2. Therefore, the upper electrode Zu[m] is supplied with the supply drive signal Vin[m] in which a voltage value starts at the reference potential V0 in the control periods TT1 and TT2, changes to the potential VS1 lower than the reference potential V0, then becomes the potential VS2 higher than the reference potential V0, and maintains the potential VS2, and at the upper electrodes Zu[1] to Zu[m−1] and Zu[m+1] to Zu[M], the reference potential V0 is held. At this time, in the discharge section D[m] to be inspected, the residual vibration is generated at the timing when the voltage value of the supply drive signal Vin[m] supplied becomes constant at the potential VS2. The piezoelectric body Zm[m] is deformed according to the residual vibration generated in the discharge section D[m] to be inspected, and the electromotive force corresponding to the deformation of the piezoelectric body Zm[m] is generated in the upper electrode Zu[m]. That is, a signal corresponding to the residual vibration generated in the discharge section D[m] to be inspected is generated in the upper electrode Zu[m] of the piezoelectric element PZ[m] included in the discharge section D[m] to be inspected. In other words, the discharge section D[m] includes the piezoelectric element PZ[m] that outputs a signal corresponding to the electromotive force generated in accordance with the residual vibration.

In the control period TT2, the switch Ws[m] is controlled to be conductive, the switches Ws[1] to Ws[m−1] and Ws[m+1] to Ws[M] are controlled to be non-conductive, and the switch Wf is controlled to be conductive. Therefore, the signal corresponding to the residual vibration generated in the discharge section D[m] to be inspected propagates through the wiring line Ls as the detection potential signal VX. At this time, the switch W1 is controlled to be conductive, and the switch W2 is controlled to be non-conductive. Therefore, in the control period TT2, the waveform shaping circuit 230 included in the detection circuit 23 does not acquire the detection potential signal VX propagating through the wiring line Ls, and thus does not output the detection signal aSK corresponding to the detection potential signal VX.

In the control period TT3, the switch W1 is controlled to be non-conductive and the switch W2 is controlled to be conductive. Thus, the waveform shaping circuit 230 included in the detection circuit 23 acquires the detection potential signal VX that is a signal corresponding to the residual vibration generated in the discharge section D[m] to be inspected and that propagates through the wiring line Ls, shapes the signal waveform of the acquired detection potential signal VX, and outputs the shaped signal waveform as the detection signal aSK. The detection signal aSK output by the waveform shaping circuit 230 is converted into a digital signal in the AD conversion circuit 231, and then is input to the determination circuit 60 as the detection signal SK.

The determination circuit 60 calculates, based on the input detection signal SK, waveform information such as the amplitude, the period, and the frequency of the detection potential signal VX, that is, waveform information such as the amplitude, the period, and the frequency of the residual vibration generated in the discharge section D[m] to be inspected. The determination circuit 60 determines the state of the discharge section D[m] to be inspected based on the calculated waveform information, and outputs the state determination signal JH indicating the determination result to the control circuit 30.

Thereafter, in the control period TT4, the switch W1 is controlled to be conductive and the switch W2 is controlled to be non-conductive, so that the waveform shaping circuit 230 stops acquiring the detection potential signal VX propagating through the wiring line Ls and outputting the detection signal aSK. In the control period TT5, the switch Wc[m] is controlled to be conductive and the switch Ws[m] is controlled to be non-conductive. Therefore, the supply of the signal generated in the upper electrode Zu[m] to the wiring line Ls is stopped, and the supply drive signal Vin[m] of the reference potential V0 is supplied to the upper electrode Zu[m] of the piezoelectric element PZ[m] included in the discharge section D[m] to be inspected. Accordingly, the potential of the upper electrode Zu[m] of the piezoelectric element PZ[m] included in the discharge section D[m] to be inspected is controlled to the reference potential V0.

### 5. CONFIGURATION AND OPERATION OF POWER SUPPLY CIRCUIT

When a voltage vdc of the power supply voltage signal VDC is higher than a voltage vhv of the power supply voltage signal VHV, the power supply circuit 50a is a step-down circuit, and when the voltage vdc of the power supply voltage signal VDC is lower than the voltage vhv of the power supply voltage signal VHV, the power supply circuit 50a is a step-up circuit. Similarly, when the voltage vdc of the power supply voltage signal VDC is higher than a voltage vdd of the power supply voltage signal VDD, the power supply circuit 50b is a step-down circuit, and when the voltage vdc of the power supply voltage signal VDC is lower than the voltage vdd of the power supply voltage signal VDD, the power supply circuit 50b is a step-up circuit. The power supply circuits 50a and 50b may have the same configuration except that they output different signals. Therefore, the power supply circuits 50a and 50b will be simply referred to as a power supply circuit 50 without distinction, and the functional configuration thereof will be described.

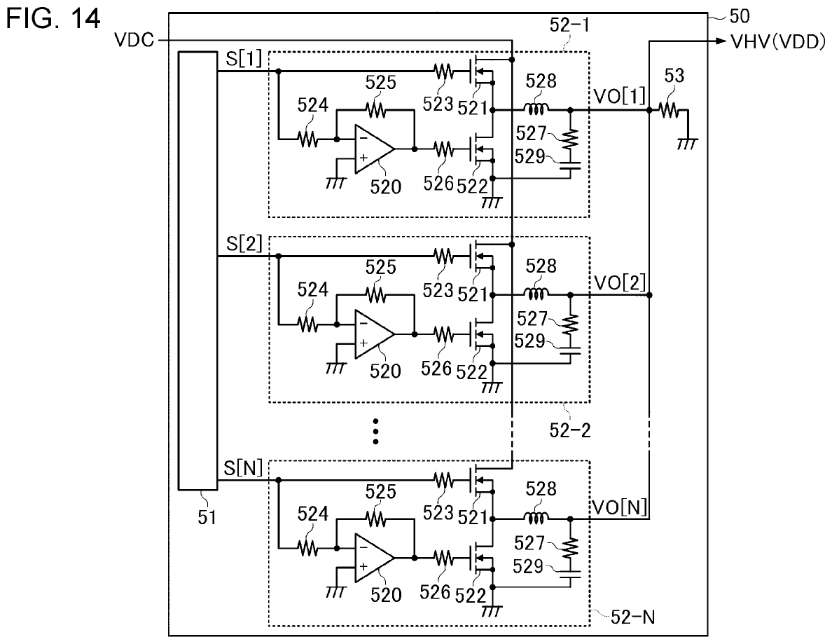

FIG. 14 is a diagram illustrating an example of a functional configuration of the power supply circuit 50 which is a step-down circuit. As illustrated in FIG. 14, the power supply circuit 50 includes a control circuit 51, N signal output circuits 52-1 to 52-N, and a resistor 53. N is any integer of 2 or more.

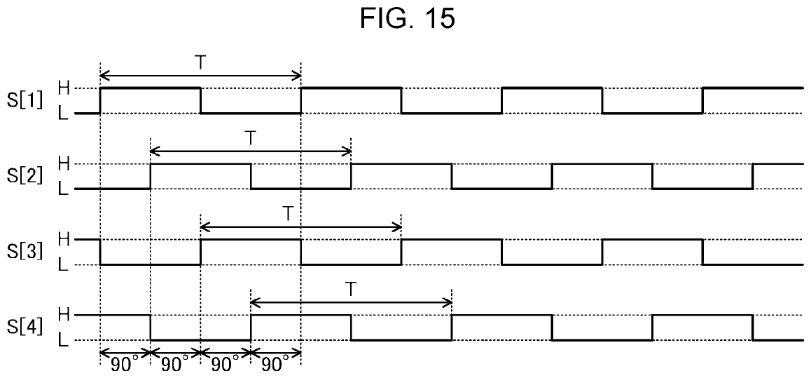

The control circuit 51 outputs control signals S[1] to S[N] to the signal output circuits 52-1 to 52-N, respectively. The control signals S[1] to S[N] switch between the H level and the L level at timings different from each other, but have the same period T and duty ratio for switching between the H level and the L level. Specifically, the control signals S[1] to S[N] have phases for switching between the H level and the L level that are shifted by 360°/N from each other, but have the same period T for switching between the H level and the L level. FIG. 15 illustrates an example of waveforms of the control signals S[1] to S[N] when N=4. In the example of FIG. 15, the control signals S[1] to S[N] have the same period T for switching the H level and the L level and the same duty ratio, but the phases thereof are shifted by 90°.

The signal output circuits 52-1 to 52-N have the same configuration, and any signal output circuit 52-i includes an operational amplifier 520, transistors 521 and 522, resistors 523 to 527, an inductor 528, and a capacitor 529.

A ground potential is supplied to a +side input terminal of the operational amplifier 520, and a −side input terminal of the operational amplifier 520 is coupled to one end of the resistor 524 and one end of the resistor 525. Further, an output terminal of the operational amplifier 520 is coupled to the other end of the resistor 525 and one end of the resistor 526. A control signal S[i] is input to the one end of the resistor 523 and the other end of the resistor 524.

The transistors 521 and 522 are, for example, an n-channel metal-oxide-semiconductor field-effect transistor (MOS-FET). The power supply voltage signal VDC is input to a drain terminal of the transistor 521. A source terminal of the transistor 521 is coupled to the drain terminal of the transistor 522. A ground potential is supplied to a source terminal of the transistor 522. In addition, the gate terminal of the transistor 521 is coupled to the other end of the resistor 523, and the gate terminal of the transistor 522 is coupled to the other end of the resistor 526.

When the control signal S[i] is at the H level, the transistor 521 is turned on, the transistor 522 is turned off, and a voltage of the node Ni to which the source terminal of the transistor 521 and the drain terminal of the transistor 522 are electrically coupled becomes the voltage vdc of the power supply voltage signal VDC. On the other hand, when the control signal S[i] is at the L level, the transistor 521 is turned off, the transistor 522 is turned on, and the voltage of the node Ni becomes the ground potential. That is, a pulse signal whose voltage is switched between the voltage vdc and the ground potential every time the control signal S[i] is switched between the H level and the L level is output from the node Ni. The duty ratio of the pulse signal changes in accordance with the duty ratio of the control signal S[i].

One end of the inductor 528 is coupled to the source terminal of the transistor 521 and the drain terminal of the transistor 522. The other end of the inductor 528 is coupled to one end of the resistor 527 and one end of the resistor 53. The ground potential is supplied to the other end of the resistor 53. The other end of the resistor 527 is coupled to one end of the capacitor 529, and the ground potential is supplied to the other end of the capacitor 529. The resistor 527, the inductor 528, and the capacitor 529 constitute a low-pass filter, and the above-described pulse signal is smoothed by the low-pass filter. The signal output circuit 52-i outputs a signal V0[i] obtained by smoothing the pulse signal. The signal V0[i] becomes a voltage vo lower than the voltage vdc, in accordance with a duty ratio of the pulse signal.

In this manner, the power supply voltage signal VDC having the voltage vdc is input to the signal output circuit 52-i, and the transistors 521 and 522 are switched on and off based on the control signal S[i]. Thus, the signal output circuit 52-i outputs the signal V0[i] held at the voltage vo.

The power supply circuit 50a outputs, as the power supply voltage signal VHV, a signal obtained by synthesizing the signals V0[1] to V0[N] respectively output from the signal output circuits 52-1 to 52-N. The power supply circuit 50a outputs, as the power supply voltage signal VDD, a signal obtained by synthesizing the signals V0[1] to V0[N] respectively output from the signal output circuits 52-1 to 52-N. That is, the power supply voltage signal VHV or the power supply voltage signal VDD is a signal obtained by synthesizing the N signals V0[1] to V0[N] output from the N signal output circuits 52-1 to 52-N.

Here, since the control signals S[1] to S[N] have the same period T and the same duty ratio, the signals V0[1] to V0[N] respectively output from the signal output circuits 52-1 to 52-N have the same voltage vo. Therefore, the power supply voltage signal VHV or the power supply voltage signal VDD is a signal of the voltage vo. In addition, since the control signals S[1] to S[N] have phases for switching between the H level and the L level that are shifted by 360°/N, timings at which the N transistors 521 included in the N signal output circuits 52-1 to 52-N are switched on and off are different from each other, and phases of these timings are shifted by 360°/N. For example, a phase difference between the timing at which the transistor 521 included in the signal output circuit 52-1 is switched on and off and the timing at which the transistor 521 included in the signal output circuit 52-2 is switched on and off is 360°/N.

Similarly, the timings at which the N transistors 522 included in the N signal output circuits 52-1 to 52-N are switched on and off are different from each other, and the phases of these timings are shifted by 360°/N. For example, the phase difference between the timing at which the transistor 522 included in the signal output circuit 52-1 is switched on and off and the timing at which the transistor 522 included in the signal output circuit 52-2 is switched on and off is 360°/N.

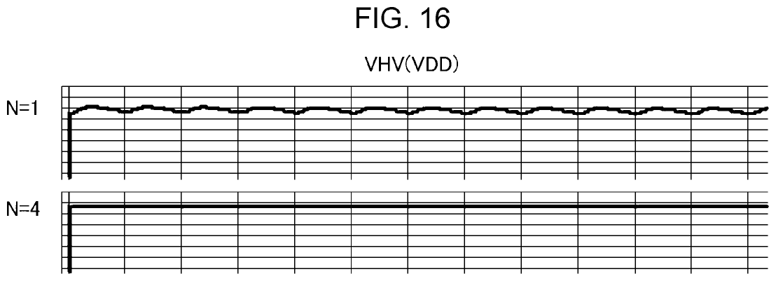

Therefore, the phases of the ripple generated in the signals V0[1] to V0[N] of the voltage vo are also shifted by 360°/N. Therefore, a ripple voltage generated in the power supply voltage signal VHV or the power supply voltage signal VDD obtained by synthesizing the signals V0[1] to V0[N] is smaller than a ripple voltage generated in each of the signals V0[1] to V0[N]. As N increases, the ripple voltage generated in the power supply voltage signal VHV or the power supply voltage signal VDD output from the power supply circuit 50 decreases. FIG. 16 illustrates examples of waveforms of the power supply voltage signal VHV or the power supply voltage signal VDD output from a power supply circuit of a comparative example corresponding to the case of N=1 and from the power supply circuit 50 corresponding to the case of N=4. As illustrated in FIG. 16, the ripple voltage is large in the power supply circuit of the comparative example, but the ripple voltage is almost zero in the power supply circuit 50 in the case of N=4.

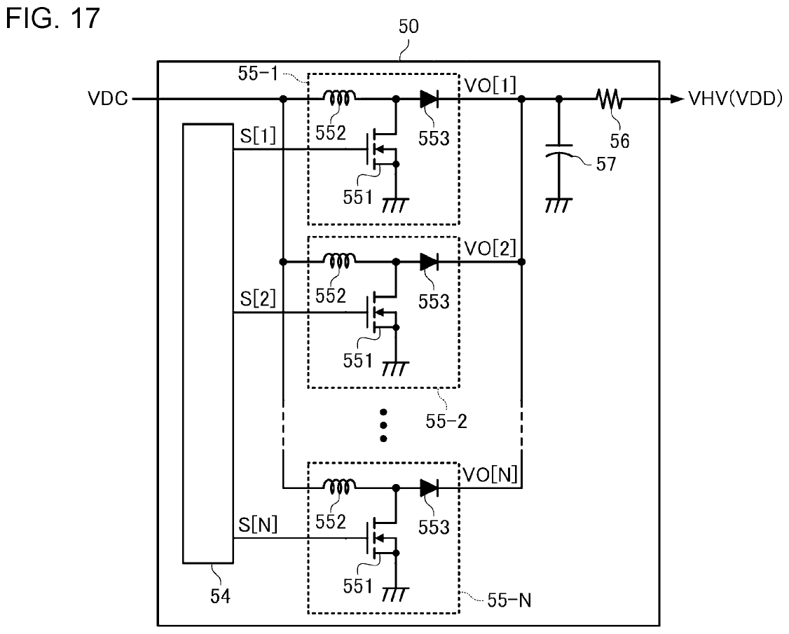

FIG. 17 is a diagram illustrating an example of a functional configuration of the power supply circuit 50 which is a step-up circuit. As illustrated in FIG. 17, the power supply circuit 50 includes a control circuit 54, N signal output circuits 55-1 to 55-N, a resistor 56, and a capacitor 57. N is any integer of 2 or more.

The control circuit 54 outputs control signals S[1] to S[N] to the signal output circuits 55-1 to 55-N, respectively. The control signals S[1] to S[N] switch between the H level and the L level at timings different from each other, but have the same period T and duty ratio for switching between the H level and the L level. Specifically, the control signals S[1] to S[N] have phases for switching between the H level and the L level that are shifted by 360°/N from each other, but have the same period T for switching between the H level and the L level. For example, the control signals S[1] to S[N] in the case of N=4 have the waveforms illustrated in FIG. 15.

The signal output circuits 55-1 to 55-N have the same configuration, and any signal output circuit 55-i includes a transistor 551, an inductor 552, and a diode 553.

The transistor 551 is, for example, an n-channel MOS-FET. A drain terminal of the transistor 551 is coupled to one end of the inductor 552 and an anode of the diode 553. The power supply voltage signal VDC is supplied to the other end of the inductor 552.

One end of the capacitor 57 and one end of the resistor 56 are commonly coupled to a cathode of the diode 553 included in each of the signal output circuits 55-1 to 55-N. The ground potential is supplied to the other end of the capacitor 57.

When the control signal S[i] is at the H level, the transistor 551 is turned on, and the drain of the transistor 551 has the ground potential. Therefore, the current flowing through the inductor 552 increases. When the control signal S[i] becomes the L level, the inductor 552 generates a counter electromotive force to maintain the current. As a result, the voltage of the anode of the diode 553 becomes higher than the voltage vdc, and a current flows through the diode 553 to charge the capacitor 57.

The signal output circuit 55-i outputs a signal V0[i] from the cathode of the diode 553. The signal V0[i] has a voltage vo higher than the voltage vdc, which corresponds to the duty ratio of the control signal S[i]. In this manner, the power supply voltage signal VDC having the voltage vdc is input to the signal output circuit 55-i, and the transistor 551 is switched on and off based on the control signal S[i]. Thus, the signal output circuit 55-i outputs the signal V0[i] held at the voltage vo.

The power supply circuit 50a outputs, as the power supply voltage signal VHV, a signal obtained by synthesizing the signals V0[1] to V0[N] respectively output from the signal output circuits 55-1 to 55-N via the resistor 56. The power supply circuit 50a outputs, as the power supply voltage signal VDD, a signal obtained by synthesizing the signals V0[1] to V0[N] respectively output from the signal output circuits 55-1 to 55-N via the resistor 56. That is, the power supply voltage signal VHV or the power supply voltage signal VDD is a signal obtained by synthesizing the N signals V0[1] to V0[N] output from the N signal output circuits 55-1 to 55-N.

Here, since the control signals S[1] to S[N] have the same period T and the same duty ratio, the signals V0[1] to V0[N] respectively output from the signal output circuits 55-1 to 55-N have the same voltage vo. Therefore, the power supply voltage signal VHV or the power supply voltage signal VDD is a signal of the voltage vo. In addition, since the control signals S[1] to S[N] have phases for switching between the H level and the L level that are shifted by 360°/N, timings at which the N transistors 551 included in the N signal output circuits 55-1 to 55-N are switched on and off are different from each other, and phases of these timings are shifted by 360°/N. For example, the phase difference between the timing at which the transistor 551 included in the signal output circuit 55-1 is switched on and off and the timing at which the transistor 551 included in the signal output circuit 55-2 is switched on and off is 360°/N.

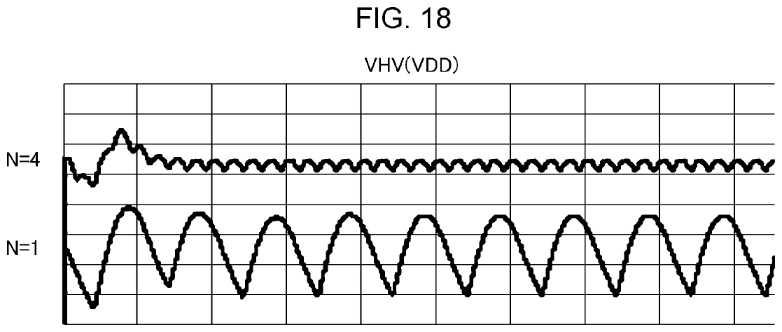

Therefore, the phases of the ripple generated in the signals V0[1] to V0[N] of the voltage vo are also shifted by 360°/N. Therefore, a ripple voltage generated in the power supply voltage signal VHV or the power supply voltage signal VDD obtained by synthesizing the signals V0[1] to V0[N] is smaller than a ripple voltage generated in each of the signals V0[1] to V0[N]. As N increases, the ripple voltage generated in the power supply voltage signal VHV or the power supply voltage signal VDD output from the power supply circuit 50 decreases. FIG. 18 illustrates examples of waveforms of the power supply voltage signal VHV or the power supply voltage signal VDD output from a power supply circuit of a comparative example corresponding to the case of N=1 and from the power supply circuit 50 corresponding to the case of N=4. As illustrated in FIG. 18, the ripple voltage is large in the power supply circuit of the comparative example, but the ripple voltage decreases to about 1/10 in the power supply circuit 50 in the case of N=4.

Further, as illustrated in FIG. 14 or FIG. 17, since the power supply circuit 50 includes a plurality of signal output circuits, the amount of current can be reduced and the heat generation stability can be improved. In addition, as the number N of signal output circuits increases, the amount of current decreases, and thus the loss is suppressed.

The configuration of the power supply circuit 50 is not limited to the configurations illustrated in FIGS. 14 and 17. For example, the power supply circuit 50 may have a configuration in which a diode is used instead of the transistor 522 in the configuration of FIG. 14.

Here, noise generated by switching of the transistors 521 and 522 is superimposed on the power supply voltage signal VHV. Therefore, the switching noise may be superimposed on the detection potential signal VX propagating through the switches Ws[1] to Ws[M] to which the power supply voltage signal VHV is supplied. Therefore, in the power supply circuit 50a, it is preferable that a period in which the transistors 521 and 522 are switched on and off is longer than a period of the residual vibration generated in the discharge section D. In this case, in the waveform shaping circuit 230 of the detection circuit 23, it is possible to attenuate the switching noise superimposed on the detection potential signal VX by the high-pass filter by appropriately setting the cut-off frequencies of the high-pass filter configured by the capacitor C1, the resistor R1, and the switch W1. As a result, the detection accuracy of the residual vibration by the detection circuit 23 is improved.

In addition, in the power supply circuit 50a, it is preferable that a ratio between the period in which the transistors 521 and 522 are switched on and off and the period of the residual vibration generated in the discharge section D is set to a value at which the residual vibration does not resonate due to the switching on and off of the transistors 521 and 522. For example, the ratio between the period in which the transistors 521 and 522 are switched on and off and the period of the residual vibration is set to a value that is not an integer. In this case, since the distortion of the waveform of the detection potential signal VX due to the resonance of the residual vibration does not occur, the detection accuracy of the residual vibration by the detection circuit 23 is improved.

The transport unit 4 is an example of a “transport section”. The switch Ws[m] is an example of a “first transmission gate”, and the switch Wc[m] is an example of a “second transmission gate”. The power supply voltage signal VHV is an example of a “first voltage signal”, and the voltage vhv held by the power supply voltage signal VHV is an example of a “first voltage”. The voltage vdc held by the power supply voltage signal VDC is an example of a “second voltage”. The signal output circuit 52-1 of the power supply circuit 50a is an example of a “first signal output circuit”, and the signal output circuit 52-2 of the power supply circuit 50a is an example of a “second signal output circuit”. The signal V0[1] output from the signal output circuit 52-1 of the power supply circuit 50a is an example of a “first signal”, and the signal V0[2] output from the signal output circuit 52-2 of the power supply circuit 50a is an example of a “second signal”. Further, the transistors 521 and 522 included in the signal output circuit 52-1 of the power supply circuit 50a are examples of “first switching elements”, respectively, and the transistors 521 and 522 included in the signal output circuit 52-2 of the power supply circuit 50a are examples of “second switching elements”, respectively. The signal output circuit 55-1 of the power supply circuit 50a is another example of the “first signal output circuit”, and the signal output circuit 55-2 of the power supply circuit 50a is another example of the “second signal output circuit”. The signal V0[1] output from the signal output circuit 55-1 of the power supply circuit 50a is another example of the “first signal”, and the signal V0[2] output from the signal output circuit 55-2 of the power supply circuit 50a is another example of the “second signal”. Further, the transistor 551 included in the signal output circuit 55-1 of the power supply circuit 50a is another example of the “first switching element”, and the transistor 551 included in the signal output circuit 55-2 of the power supply circuit 50a is another example of the “second switching element”.

### 6. OPERATIONAL EFFECTS

As described above, in the liquid discharge apparatus 1 of the present embodiment, the power supply circuit 50 includes a switching power supply circuit, and generates and outputs the power supply voltage signal VHV or the power supply voltage signal VDD from the power supply voltage signal VDC by the operation of the switching power supply circuit. In the power supply circuit 50 including the switching power supply circuit, power consumption can be reduced as compared with a case where a linear power supply circuit is included. On the other hand, since the power supply circuit 50 generates the power supply voltage signal VHV or the power supply voltage signal VDD by smoothing the pulse signal whose voltage is switched between the voltage vdc of the power supply voltage signal VDC and the ground potential, a ripple occurs in the power supply voltage signal VHV or the power supply voltage signal VDD to be output.

The power supply voltage signal VHV is supplied, as the coupling state designation signals Qc[m] and Qs[m], to gate terminals of the transistors Wnm and Wpm included in the respective switches Wc[m] and Ws[m], and is also supplied to back gate terminals of the transistors Wpm included in the respective switches Wc[m] and Ws[m]. At this time, the ripple generated in the power supply voltage signal VHV may be superimposed on the drive signal Com propagated through the wiring line Lc or on the detection potential signal VX propagated through the wiring line Ls based on the residual vibration generated in the discharge section D[m] to be inspected, via the parasitic capacitance between the gate terminal and the drain terminal and the source terminal of the transistors Wnm and Wpm, the parasitic capacitance between the back gate terminal and the drain terminal and the source terminal of the transistors Wpm, or the like. In particular, while a voltage amplitude of the detection potential signal VX is approximately several tens of mV to 100 mV, a voltage amplitude of ripple generated in the power supply voltage signal VHV may reach several tens of mV to 100 mV. When the ripple generated in the power supply voltage signal VHV is superimposed on the detection potential signal VX, a waveform of the detection potential signal VX is distorted, and waveform information such as its amplitude, attenuation rate of amplitude, period, and frequency is significantly changed. As a result, there is a possibility that the detection accuracy of the residual vibration by the detection circuit 23 decreases, and the determination accuracy of the state of the discharge section D[m] to be inspected in the determination circuit 60 decreases.

The power supply voltage signal VDD is supplied to the operational amplifiers OP1 and OP2 included in the waveform shaping circuit 230 of the detection circuit 23. At this time, there is a possibility that the ripple generated in the power supply voltage signal VDD is superimposed on output signals of the operational amplifiers OP1 and OP2, respectively. As a result, there is a possibility that the detection accuracy of the residual vibration by the detection circuit 23 decreases, and the determination accuracy of the state of the discharge section D[m] to be inspected in the determination circuit 60 decreases.

In contrast, in the liquid discharge apparatus 1 according to the present embodiment, the transistors 521 and 522 of the signal output circuits 52-1 to 52-N are operated at timings different from each other in the power supply circuit 50a which is a step-down circuit, and thus the phases of the ripple generated in the signals V0[1] to V0[N] become different. Similarly, in the power supply circuit 50a which is a step-up circuit, the transistors 551 of the signal output circuits 55-1 to 55-N are operated at timings different from each other, and thus the phases of the ripple generated in the signals V0[1] to V0[N] become different. Therefore, by synthesizing the signals V0[1] to V0[N], ripple generated in the signals V0[1] to V0[N] cancels each other, and ripple generated in the power supply voltage signal VHV after synthesis is reduced. In particular, the larger a difference between the voltage vdc of the power supply voltage signal VDC input to the power supply circuit 50a and the voltage vhv of the power supply voltage signal VHV output therefrom, the higher an effect of ripple reduction. In addition, by shifting the phases of the ripple generated in the signals V0[1] to V0[N] by 360°/N, ripple generated in the signals V0[1] to V0[N] cancels each other very effectively, and ripple generated in the power supply voltage signal VHV after synthesis is minimized.

Then, by reducing the ripple generated in the power supply voltage signal VHV, distortion caused by ripple of the power supply voltage signal VHV supplied to the switch Ws[m] is reduced when a minute detection potential signal VX based on the residual vibration propagates through the switch Ws[m]. Therefore, according to the liquid discharge apparatus 1 of the present embodiment, a possibility that the detection accuracy of the residual vibration by the detection circuit 23 decreases due to the operation of the switch Ws[m] is reduced. In addition, according to the liquid discharge apparatus 1 of the present embodiment, in the power supply circuit 50a, since the load is distributed to the N signal output circuits 52-1 to 52-N or the N signal output circuits 55-1 to 55-N, it is possible to reduce the amount of current and to increase heat generation reliability.

Similarly, in the liquid discharge apparatus 1 according to the present embodiment, in the power supply circuit 50b, the signals V0[1] to V0[N] having different ripple phases are synthesized and thus the ripple generated in the signals V0[1] to V0[N] cancels each other and the ripple generated in the power supply voltage signal VDD after the synthesis is reduced. In particular, the larger a difference between the voltage vdc of the power supply voltage signal VDC input to the power supply circuit 50b and the voltage vdd of the power supply voltage signal VDD output therefrom, the higher an effect of ripple reduction. In addition, by shifting the phases of the ripple generated in the signals V0[1] to V0[N] by 360°/N, ripple generated in the signals V0[1] to V0[N] cancels each other very effectively, and ripple generated in the power supply voltage signal VDD after synthesis is minimized.

Then, by reducing the ripple generated in the power supply voltage signal VDD, distortion occurring in output signals of the operational amplifiers OP1 and OP2, which are included in the detection circuit 23 and supplied with the power supply voltage signal VDD, is reduced. Therefore, according to the liquid discharge apparatus 1 of the present embodiment, a possibility that detection accuracy of residual vibration decreases due to operation of the operational amplifiers OP1 and OP2 is reduced. In addition, according to the liquid discharge apparatus 1 of the present embodiment, in the power supply circuit 50b, since the load is distributed to the N signal output circuits 52-1 to 52-N or the N signal output circuits 55-1 to 55-N, it is possible to reduce the amount of current and to increase heat generation reliability.

In addition, in the liquid discharge apparatus 1 of the present embodiment, even if noise caused by the ripple generated in the power supply voltage signal VHV is superimposed when the minute detection potential signal VX based on the residual vibration propagates through the switch Ws[m], since the period of the noise is longer than the period of the residual vibration, the noise is attenuated by the high-pass filter configured with the capacitor C1, the resistor R1, and the switch W1 of the detection circuit 23. Therefore, according to the liquid discharge apparatus 1 of the present embodiment, a possibility that the detection accuracy of the residual vibration by the detection circuit 23 decreases due to the operation of the switch Ws[m] is reduced.

In addition, in the liquid discharge apparatus 1 of the present embodiment, when the ratio between the switching period of the switch Ws[m] and the period of the residual vibration is set to a value at which the residual vibration does not resonate due to the switching operation of the switch Ws[m], since the possibility that the waveform of the minute detection potential signal VX based on the residual vibration is distorted by the resonance is reduced, a possibility that the detection accuracy of the residual vibration by the detection circuit 23 decreases.

In addition, according to the liquid discharge apparatus 1 of the present embodiment, since the power supply voltage signal VHV is shared by the switches Wc[1] to Wc[M], Ws[1] to Ws[M], Wf, and the drive circuit 40, the area of the power supply circuit 50a is reduced. Similarly, since the power supply voltage signal VDD is shared by the control circuit 30, the drive circuit 40, and the determination circuit 60, the area of the power supply circuit 50b is reduced.

### 7. MODIFICATION

The present disclosure is not limited to the present embodiment, and various modifications may be made without departing from the scope of the present disclosure.

For example, in the above-described embodiment, the piezoelectric element PZ discharges ink from the discharge section D by being driven and outputs a signal corresponding to the residual vibration generated in the discharge section D, but the discharge section D may be configured to individually include a piezoelectric element as a drive element for discharging ink and a piezoelectric element as a detection element for detecting the residual vibration generated in the discharge section D. In addition, at this time, the drive element for discharging the ink in the discharge section D is not limited to the piezoelectric element as long as the element can convert an electric signal into a mechanical vibration, and the detection element for detecting the residual vibration generated in the discharge section D is not limited to the piezoelectric element as long as the element can convert the mechanical vibration into an electric signal.

In addition, in the above-described embodiment, the potential generated in the upper electrode Zu of the piezoelectric element PZ is output as a signal corresponding to the residual vibration generated in the discharge section D, but the potential generated in the lower electrode Zd of the piezoelectric element PZ may be output as a signal corresponding to the residual vibration generated in the discharge section D. In addition, the signal corresponding to the residual vibration generated in the discharge section D may be a signal in which a current vibrates in accordance with the residual vibration generated in the discharge section D, or may be a signal in which a voltage vibrates in accordance with the residual vibration generated in the discharge section D. Therefore, the detection circuit 23 may be configured to detect a voltage value of a signal corresponding to the residual vibration generated in the discharge section D, or may be configured to detect a current value of the signal corresponding to the residual vibration generated in the discharge section D.

In addition, in the above-described embodiment, the signal waveform of the drive signal Com output by the drive circuit 40 is switched between the drive waveforms PP1 and PP2, the drive waveform PS, and the drive waveform PC, but the drive circuit 40 may individually include an amplifier circuit that outputs the drive waveforms PP1 and PP2, an amplifier circuit that outputs the drive waveform PS, and an amplifier circuit that outputs the drive waveform PC.

Further, in the above-described embodiment, the power supply voltage signal VHV output from the power supply circuit 50a is supplied to the drive circuit 40 and the switches Wc[1] to Wc[M], Ws[1] to Ws[M], and Wf, but may not be supplied to the drive circuit 40. That is, the power supply voltage signal VHV output from the power supply circuit 50a may be supplied only to the switches Wc[1] to Wc[M], Ws[1] to Ws[M], and Wf which are transmission gates.

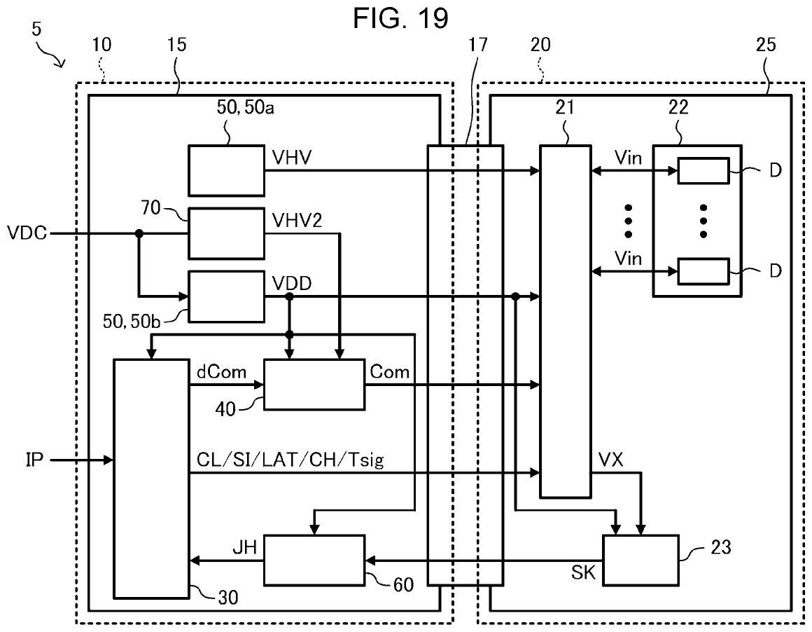

FIG. 19 is a diagram illustrating an example of a functional configuration of a head unit 5 according to the modification. In the example of FIG. 19, a power supply circuit 70 is further provided on a wiring substrate 15. The power supply voltage signal VDC is input to the power supply circuit 70. The power supply circuit 70 generates and outputs a power supply voltage signal VHV2, which is a constant DC voltage signal by stepping down or stepping up the power supply voltage signal VDC. For example, the voltage of the power supply voltage signal VHV2 is the same as the voltage of the power supply voltage signal VHV output from the power supply circuit 50a. The power supply voltage signal VHV output from the power supply circuit 50a is supplied to the switches Wc[1] to Wc[M], Ws[1] to Ws[M], and Wf included in the print head 25 via the coupling member 17, and the power supply voltage signal VHV2 output from the power supply circuit 70 is supplied to the drive circuit 40. The power supply circuit 70 may have the same configuration as the power supply circuit 50a, or may have a different configuration. For example, the power supply circuit 70 may have a configuration of N≥2 illustrated in FIG. 14, or may have a configuration corresponding to the case of N=1 in FIG. 14. According to the liquid discharge apparatus 1 of the modification, in the head unit 5, noise generated by the operation of the drive circuit 40 is not superimposed on the power supply voltage signal VHV. Therefore, since distortion of the waveform of the detection potential signal VX due to the noise does not occur, the detection accuracy of the residual vibration by the detection circuit 23 is improved.

Further, the power supply voltage signal VHV output from the power supply circuit 50a may be supplied to the switches Ws[1] to Ws[M] and may not be supplied to the drive circuit 40 and the switches Wc[1] to Wc[M], and Wf. That is, the power supply voltage signal VHV output from the power supply circuit 50a may be supplied only to the switches Ws[1] to Ws[M] which are transmission gates capable of switching conduction and non-conduction between the discharge section D[m] and the detection circuit 23.

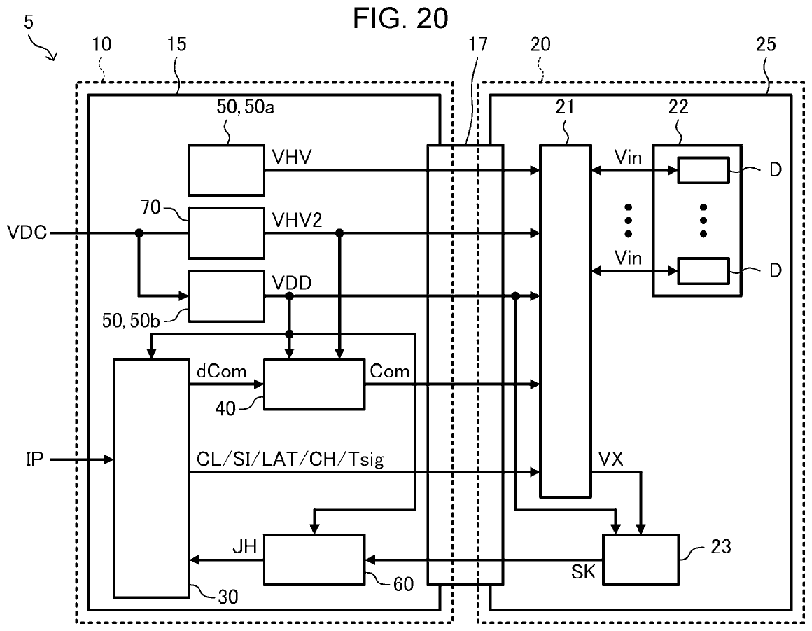

FIG. 20 is a diagram illustrating an example of a functional configuration of a head unit 5 according to the modification. In the example of FIG. 20, the wiring substrate 15 is further provided with a power supply circuit 70 similar to that of FIG. 19. The power supply voltage signal VHV output from the power supply circuit 50a is supplied to the switches Ws[1] to Ws[M] included in the print head 25 via the coupling member 17, and the power supply voltage signal VHV2 output from the power supply circuit 70 is supplied to the drive circuit 40 and is supplied to the switches Wc[1] to Wc[M] and Wf included in the print head 25 via the coupling member 17. According to the liquid discharge apparatus 1 of the modification, in the head unit 5, noise generated by the operation of the drive circuit 40 is not superimposed on the detection potential signal VX via the switches Wc[1] to Wc[M], and Wf. Therefore, since distortion of the waveform of the detection potential signal VX due to the noise does not occur, the detection accuracy of the residual vibration by the detection circuit 23 is improved.

Although the present embodiment and the modification examples have been described above, the present disclosure is not limited to the present embodiment and the modification, and can be implemented in various aspects within the scope not departing from the concept of the present disclosure. For example, each embodiment and each modification described above may be combined as appropriate.

The present disclosure includes configurations that are substantially the same as the configurations described in the embodiments, for example, a configuration having the same functions, methods, and results as those described in the embodiments, or a configuration having the same objects and effects as those described in the embodiments. The present disclosure includes configurations in which non-essential portions of the configurations described in the embodiments are replaced. In addition, the present disclosure includes configurations that achieve the same operational effects or configurations that can achieve the same objects as those of the configurations described in the embodiments. In addition, the present disclosure includes configurations in which a known technique is added to the configurations described in the embodiments.

The following contents are derived from the above-described embodiments and modifications.

One aspect of a liquid discharge apparatus includes a transport section configured to transport a medium, a discharge section configured to discharge liquid by supply of a drive signal, a detection circuit configured to detect residual vibration generated in the discharge section, a determination circuit configured to determine whether or not the discharge section is normal in accordance with the residual vibration detected by the detection circuit, a first transmission gate to which a first voltage signal held at a first voltage is supplied, the first transmission gate being configured to switch conduction and non-conduction between the discharge section and the detection circuit, a first signal output circuit to which a second voltage different from the first voltage is input, the first signal output circuit being configured to output a first signal held at the first voltage by switching on and off of a first switching element, and a second signal output circuit to which the second voltage is input, the second signal output circuit being configured to output a second signal held at the first voltage by switching on and off of a second switching element at a timing different from a timing at which the first switching element is switched on and off, in which the first voltage signal is a signal obtained by synthesizing at least the first signal and the second signal.

In the liquid discharge apparatus, by operating the first switching element of the first signal output circuit and the second switching element of the second signal output circuit at different timings from each other, the phase of the ripple generated in the first signal and the phase of the ripple generated in the second signal are different from each other. Therefore, by synthesizing the first signal and the second signal, the ripple generated in the first signal and the ripple generated in the second signal cancel each other, and the ripple generated in the first voltage signal after the synthesis is reduced. In particular, the larger the difference between the second voltage input to the first signal output circuit and the second signal output circuit and the first voltage of the first voltage signal that is output, the higher the ripple reduction effect. Since the ripple generated in the first voltage signal is reduced, distortion caused by the ripple of the first voltage signal supplied to the first transmission gate when a minute signal based on the residual vibration propagates through the first transmission gate is reduced. Therefore, according to the liquid discharge apparatus, it is possible to reduce a possibility that the detection accuracy of the residual vibration decreases due to the operation of the first transmission gate. In addition, according to the liquid discharge apparatus, since the load is distributed to the first signal output circuit and the second signal output circuit, it is possible to increase heat generation stability by reducing the amount of current.

In one aspect of the liquid discharge apparatus, the second voltage may be higher than the first voltage.

According to the liquid discharge apparatus, it is possible to generate the first voltage signal in which the ripple is reduced by stepping down the second voltage.

In one aspect of the liquid discharge apparatus, the second voltage may be lower than the first voltage.

According to the liquid discharge apparatus, it is possible to generate the first voltage signal in which the ripple is reduced by stepping up the second voltage.

In one aspect of the liquid discharge apparatus, the detection circuit may include a high-pass filter, and a period at which the first switching element is switched on and off may be longer than a period of the residual vibration.

In the liquid discharge apparatus, even if noise caused by the ripple generated in the first voltage signal is superimposed when the minute signal based on the residual vibration propagates through the first transmission gate, since the period of the noise is longer than the period of the residual vibration, the noise is attenuated by the high-pass filter of the detection circuit. Therefore, according to the liquid discharge apparatus, it is possible to reduce a possibility that the detection accuracy of the residual vibration decreases due to the operation of the first transmission gate.

In one aspect of the liquid discharge apparatus, a ratio between the period at which the first switching element is switched on and off and the period of the residual vibration may be set to a value such that the residual vibration does not resonate due to switching on and off of the first switching element.

According to the liquid discharge apparatus, since the possibility that the waveform of the minute signal based on the residual vibration is distorted by the resonance is reduced, the possibility that the detection accuracy of the residual vibration decreases is reduced.

In one aspect of the liquid discharge apparatus, the liquid discharge apparatus may include a drive circuit configured to generate the drive signal, and a second transmission gate configured to switch conduction and non-conduction between the drive circuit and the discharge section, in which the first voltage signal may be also supplied to the second transmission gate and the drive circuit.

According to the liquid discharge apparatus, since the first voltage signal is shared by the first transmission gate through which the signal based on the residual vibration propagates, the second transmission gate through which the drive signal propagates, and the drive circuit that outputs the drive signal, the circuit area is reduced.

In one aspect of the liquid discharge apparatus, the liquid discharge apparatus may include a drive circuit configured to generate the drive signal, and a second transmission gate configured to switch conduction and non-conduction between the drive circuit and the discharge section, and the first voltage signal may be supplied to the first transmission gate and the second transmission gate and may not be supplied to the drive circuit.

According to the liquid discharge apparatus, since the first voltage signal is not supplied to the drive circuit, a minute signal based on the residual vibration is not distorted due to the operation of the drive circuit, and a possibility that the detection accuracy of the residual vibration decreases is reduced.

In one aspect of the liquid discharge apparatus, the liquid discharge apparatus may include a drive circuit configured to generate the drive signal, and a second transmission gate configured to switch conduction and non-conduction between the drive circuit and the discharge section, and the first voltage signal may be supplied to the first transmission gate and may not be supplied to the second transmission gate and the drive circuit.

According to the liquid discharge apparatus, since the first voltage signal is not supplied to the second transmission gate and the drive circuit, a minute signal based on the residual vibration is not distorted due to the operation of the drive circuit or the second transmission gate, and a possibility that the detection accuracy of the residual vibration decreases is reduced.

In one aspect of the liquid discharge apparatus, the liquid discharge apparatus may further include N signal output circuits including the first signal output circuit and the second signal output circuit, in which each of the N signal output circuits may receive the second voltage and output a signal held at the first voltage by switching on and off of a switching element, timings at which the N switching elements included in the N signal output circuits are switched on and off may be different from each other, a phase difference between a timing at which the first switching element is switched on and off and a timing at which the second switching element is switched on and off may be 360°/N, and the first voltage signal may be a signal obtained by synthesizing the N signals output from the N signal output circuits.

In the liquid discharge apparatus, the N switching elements included in the N signal output circuits are operated at timings shifted in phase by 360°/N from each other, and thus the phase of ripple generated in the N signals to be output is shifted by 360°/N. Therefore, by synthesizing the N signals, ripple generated in the N signals is canceled out very effectively, and ripple generated in the first voltage signal after synthesis is minimized. Therefore, according to the liquid discharge apparatus, it is possible to reduce a possibility that the detection accuracy of the residual vibration decreases due to the operation of the first transmission gate. In addition, according to the liquid discharge apparatus, since the load is distributed to the N signal output circuits, it is possible to increase the heat generation stability by reducing the amount of current.

One aspect of a head unit includes a discharge section configured to discharge liquid by supply of a drive signal, a detection circuit configured to detect residual vibration generated in the discharge section, a determination circuit configured to determine whether or not the discharge section is normal in accordance with the residual vibration detected by the detection circuit, a first transmission gate to which a first voltage signal held at a first voltage is supplied, the first transmission gate being configured to switch conduction and non-conduction between the discharge section and the detection circuit, a first signal output circuit to which a second voltage different from the first voltage is input, the first signal output circuit being configured to output a first signal held at the first voltage by switching on and off of a first switching element, and a second signal output circuit to which the second voltage is input, the second signal output circuit being configured to output a second signal held at the first voltage by switching on and off of a second switching element at a timing different from a timing at which the first switching element is switched on and off, in which the first voltage signal is a signal obtained by synthesizing at least the first signal and the second signal.

In one aspect of the head unit, the second voltage may be higher than the first voltage.

In one aspect of the head unit, the second voltage may be lower than the first voltage.

In one aspect of the head unit, the detection circuit may include a high-pass filter, and a period at which the first switching element is switched on and off may be longer than a period of the residual vibration.

In one aspect of the head unit, a ratio between the period at which the first switching element is switched on and off and the period of the residual vibration may be set to a value such that the residual vibration does not resonate due to switching on and off of the first switching element.

In one aspect of the head unit, the head unit may include a drive circuit configured to generate the drive signal, and a second transmission gate configured to switch conduction and non-conduction between the drive circuit and the discharge section, and the first voltage signal may also be supplied to the second transmission gate and the drive circuit.

In one aspect of the head unit, the head unit may include a drive circuit configured to generate the drive signal, and a second transmission gate configured to switch conduction and non-conduction between the drive circuit and the discharge section, and the first voltage signal may be supplied to the first transmission gate and the second transmission gate and may not be supplied to the drive circuit.

In one aspect of the head unit, the head unit may include a drive circuit configured to generate the drive signal, and a second transmission gate configured to switch conduction and non-conduction between the drive circuit and the discharge section, and the first voltage signal may be supplied to the first transmission gate and may not be supplied to the second transmission gate and the drive circuit.

In one aspect of the head unit, the head unit may further include N signal output circuits including the first signal output circuit and the second signal output circuit, in which each of the N signal output circuits may receive the second voltage and output a signal held at the first voltage by switching on and off of a switching element, timings at which the N switching elements included in the N signal output circuits are switched on and off may be different from each other, a phase difference between a timing at which the first switching element is switched on and off and a timing at which the second switching element is switched on and off may be 360°/N, and the first voltage signal may be a signal obtained by synthesizing the N signals output from the N signal output circuits.

What is claimed is:

1. A liquid discharge apparatus comprising:
a transport section configured to transport a medium;
a discharge section configured to discharge liquid by supply of a drive signal;
a detection circuit configured to detect residual vibration generated in the discharge section;
a determination circuit configured to determine whether or not the discharge section is normal in accordance with the residual vibration;
a first transmission gate to which a first voltage signal held at a first voltage is supplied and configured to selectively couple the discharge section and the detection circuit;
a first signal output circuit to which a second voltage is input and configured to output a first signal held at the first voltage by switching on and off of a first switching element; and
a second signal output circuit to which the second voltage is input and configured to output a second signal held at the first voltage by switching on and off of a second switching element at a timing different from a timing at which the first switching element is switched on and off, wherein
the first voltage signal is a signal obtained by synthesizing at least the first signal and the second signal.

2. The liquid discharge apparatus according to claim 1, wherein
the second voltage is higher than the first voltage.

3. The liquid discharge apparatus according to claim 1, wherein
the second voltage is lower than the first voltage.

4. The liquid discharge apparatus according to claim 1, wherein
the detection circuit includes
a high-pass filter, and
a period at which the first switching element is switched on and off is longer than a period of the residual vibration.

5. The liquid discharge apparatus according to claim 4, wherein
a ratio between the period at which the first switching element is switched on and off and the period of the residual vibration is set to a value such that the residual vibration does not resonate due to switching on and off of the first switching element.

6. The liquid discharge apparatus according to claim 1, further comprising:
a drive circuit configured to generate the drive signal; and
a second transmission gate configured to selectively couple the drive circuit and the discharge section, wherein
the first voltage signal is also supplied to the second transmission gate and the drive circuit.

7. The liquid discharge apparatus according to claim 1, further comprising:
a drive circuit configured to generate the drive signal; and
a second transmission gate configured to selectively couple the drive circuit and the discharge section, wherein
the first voltage signal is supplied to the first transmission gate and the second transmission gate and is not supplied to the drive circuit.

8. The liquid discharge apparatus according to claim 1, further comprising:
a drive circuit configured to generate the drive signal; and
a second transmission gate configured to selectively couple the drive circuit and the discharge section, wherein
the first voltage signal is supplied to the first transmission gate and is not supplied to the second transmission gate and the drive circuit.

9. The liquid discharge apparatus according to claim 1, further comprising:
N signal output circuits including the first signal output circuit and the second signal output circuit, wherein
each of the N signal output circuits receives the second voltage and outputs a signal held at the first voltage by switching on and off of a switching element,
timings at which the N switching elements included in the N signal output circuits are switched on and off are different from each other,
a phase difference between a timing at which the first switching element is switched on and off and a timing at which the second switching element is switched on and off is 360°/N, and
the first voltage signal is a signal obtained by synthesizing the N signals output from the N signal output circuits.

10. A head unit comprising:
a discharge section configured to discharge liquid by supply of a drive signal;
a detection circuit configured to detect residual vibration generated in the discharge section;
a determination circuit configured to determine whether or not the discharge section is normal in accordance with the residual vibration;
a first transmission gate to which a first voltage signal held at a first voltage is supplied and configured to selectively couple the discharge section and the detection circuit;
a first signal output circuit to which a second voltage is input and configured to output a first signal held at the first voltage by switching on and off of a first switching element; and
a second signal output circuit to which the second voltage is input and configured to output a second signal held at the first voltage by switching on and off of a second switching element at a timing different from a timing at which the first switching element is switched on and off, wherein
the first voltage signal is a signal obtained by synthesizing at least the first signal and the second signal.

11. The head unit according to claim 10, wherein
the second voltage is higher than the first voltage.

12. The head unit according to claim 10, wherein
the second voltage is lower than the first voltage.

13. The head unit according to claim 10, wherein
the detection circuit includes
a high-pass filter, and
a period at which the first switching element is switched on and off is longer than a period of the residual vibration.

14. The head unit according to claim 13, wherein
a ratio between the period at which the first switching element is switched on and off and the period of the residual vibration is set to a value such that the residual vibration does not resonate due to switching on and off of the first switching element.

15. The head unit according to claim 10, further comprising:
a drive circuit configured to generate the drive signal; and
a second transmission gate configured to selectively couple the drive circuit and the discharge section, wherein
the first voltage signal is also supplied to the second transmission gate and the drive circuit.

16. The head unit according to claim 10, further comprising:
a drive circuit configured to generate the drive signal; and
a second transmission gate configured to selectively couple the drive circuit and the discharge section, wherein
the first voltage signal is supplied to the first transmission gate and the second transmission gate and is not supplied to the drive circuit.

17. The head unit according to claim 10 further comprising:
a drive circuit configured to generate the drive signal; and
a second transmission gate configured to selectively couple the drive circuit and the discharge section, wherein
the first voltage signal is supplied to the first transmission gate and is not supplied to the second transmission gate and the drive circuit.

18. The head unit according to claim 10, further comprising:
N signal output circuits including the first signal output circuit and the second signal output circuit, wherein
each of the N signal output circuits receives the second voltage and outputs a signal held at the first voltage by switching on and off of a switching element,
timings at which the N switching elements included in the N signal output circuits are switched on and off are different from each other,
a phase difference between a timing at which the first switching element is switched on and off and a timing at which the second switching element is switched on and off is 360°/N, and
the first voltage signal is a signal obtained by synthesizing the N signals output from the N signal output circuits.
